(19) United States
(12) Patent Application Publication
(10) Pub. No.: US 2005/0151804 A1
(43) Pub. Date: Jul. 14, 2005

(54) Function liquid supply apparatus, imaging apparatus, method of manufacturing electro-optical device, electro-optical device, and electronic device

(76) Inventors: Takayuki Hayashi, Nagano-ken (JP); Kenichi Ono, Sakata-shi (JP)

Correspondence Address: HARNESS, DICKEY & PIERCE, P.L.C., P.O. BOX 828, BLOOMFIELD HILLS, MI, 48303, US

(21) Appl. No.: 11/032,180

(22) Filed: Jan. 10, 2005

(30) Foreign Application Priority Data
Jan. 8, 2004 (JP) 2004-003469
Aug. 20, 2004 (JP) 2004-241174

(51) Int. Cl. B41J 2/175

(52) U.S. Cl. 347/85

(57) ABSTRACT

A function liquid supply apparatus has a function liquid tank and a pressure adjustment valve. The pressure adjustment valve includes a primary chamber for receiving the function liquid from the function liquid tank, a secondary chamber communicated with the primary chamber through a communication flow passage, and a diaphragm forming one face of the secondary chamber and exposed to atmosphere such that atmospheric pressure received by the diaphragm serves as a reference adjustment pressure to control the fluid flow through the communication flow passage. The apparatus also has a connecting tube for connecting the function liquid tank to the function liquid droplet ejection head through the pressure adjustment valve. The function liquid tank and the pressure adjustment valve are mounted on the carriage.

### RELATED APPLICATIONS

This application claims priority to Japanese Patent Application No. 2004-003469 filed Jan. 8, 2004 and 2004-241174 filed Aug. 20, 2004.

### BACKGROUND OF THE INVENTION

1. Field of the Invention

This invention relates to a function liquid (or functional liquid) supply apparatus for supplying function liquid to a function liquid droplet ejection (or discharge) head mounted on a carriage, an imaging apparatus, a method of manufacturing an electro-optical device, an electro-optical device, and an electronic device.

2. Description of the Related Art

An ink-jet printer which is a kind-of imaging apparatus has the following arrangement or configuration. Namely, in order to prevent unintended drip of ink (function liquid) from an ink jet head (function liquid droplet ejection head), and also in order to secure a quantitative stability in the ink droplets to be ejected from the ink jet ejection head, an ink pack (function liquid tank) for supplying the ink jet head with the ink is disposed at a position lower than (a nozzle surface of) the ink jet head so as to attain a predetermined water head difference. While performing a relative movement between the ink jet head and an object to be printed (work or workpiece), the ink jet head is driven to eject the ink, whereby printing (or imaging) is performed on the work.

An industrially applied imaging apparatus has a configuration such that the function liquid droplet ejection head is positioned with a narrow gap between the nozzle face and the work in order to avoid a crooked or curved flight of the function liquid droplets, thereby attaining a high imaging accuracy.

Therefore, if an attempt is made to dispose the function liquid tank at a position lower than the (nozzle face of the) function liquid droplet ejection head, the function liquid tank must be disposed so as to stay clear of a region in which the relative movement is performed between the work and the function liquid droplet ejection head. In other words, there is no freedom in the laying out the function liquid tank, resulting in the necessity of disposing the function liquid tank outside the region of movement of the function liquid droplet ejection head. This brings about the problem in that the apparatus itself becomes large in size.

On the other hand, the function liquid droplet ejection head containing air bubbles leads to the problem of dropout of dots, or the like. Therefore, the function liquid shall preferably be supplied to the function liquid droplet ejection head at a highly deaerated or degassed state (i.e., in a state in which the air bubbles are removed to the extent possible). However, if the function liquid tank is disposed outside the region of movement of the function liquid droplet ejection head, the flow passages of the function liquid from the function liquid tank to the function liquid droplet ejection head becomes long. This results in an increase in the amount of air dissolved into the function liquid on the way of transport through function liquid flow passages, the increase in the dissolved air amount being caused through the function liquid tubes which constitute the function liquid flow passages. Furthermore, if the function liquid flow passages become long, the amount of the function liquid to remain inside the flow passages becomes large, resulting in an amount of function liquid to be wasted, as well as in a loss of function liquid supply pressure through the flow passage.

### SUMMARY OF THE INVENTION

Accordingly, it is an object of this invention to provide a function liquid supply apparatus; an imaging apparatus; a method of manufacturing an electro-optical device; an electro-optical device; and an electronic device in which the freedom of laying out (or disposing) the function liquid tank is secured and in which the flow passages of the function liquid can e shortened.

According to one aspect of this invention, there is provided a function liquid supply apparatus for supplying a function liquid to a function liquid droplet ejection head mounted on a carriage. The apparatus comprises: a function liquid tank for supplying the function liquid; and a pressure adjustment valve. The pressure adjustment valve comprises: a primary chamber for receiving the function liquid from the function liquid tank; a secondary chamber in fluid flow communication with the primary chamber through a communication flow passage, the secondary chamber being communicated with the function liquid droplet ejection head; and a diaphragm forming one face of the secondary chamber and exposed to atmosphere such that atmospheric pressure received by the diaphragm serves as a reference adjustment pressure to control the fluid flow through the communication flow passage. The apparatus further comprises a connecting tube for connecting the function liquid tank to the function liquid droplet ejection head through the pressure adjustment valve. The function liquid tank and the pressure adjustment valve are mounted on the carriage.

According to this invention, the function liquid tank and the pressure adjustment valve are mounted on the same carriage as the function liquid droplet ejection head. Therefore, the length of the connecting tube, i.e., the length of the flow passage of the function liquid, can be shortened. Further, since there is disposed, between the function liquid tank and the function liquid droplet ejection head, the pressure adjustment valve which uses the atmospheric pressure as the reference adjustment pressure, it is not necessary to take into consideration the difference in head pressure between the function liquid tank and the function liquid droplet ejection head.

Preferably, the manner of mounting the function liquid tank and the pressure adjustment valve on the carriage is such that the function liquid is supplied from the function liquid tank to the function liquid droplet ejection head by natural flow.

According to this preferred embodiment, the function liquid tank and the pressure adjustment valve are mounted on the carriage such that the function liquid naturally flows down. Therefore, it is possible to supply the function liquid droplet ejection head with the function liquid by natural flow (caused by head pressure difference). Accordingly, there is no need of providing a particular device for supplying the function liquid to the function liquid droplet ejection head, thereby preventing the function liquid supply apparatus from becoming large in size.

Preferably, the function liquid tank is of a vacuum-packed type to store therein the function liquid subjected to degassing processing in advance.

According to this preferred embodiment, the pack shrinks accompanied by the decrease in the function liquid stored in the pack, thereby having the advantage in that the function liquid is stored in the pack without being exposed to air, and thereby enabling supply of the function liquid subjected to degassing (or deaerating) processing while maintaining the highly degassed state.

Preferably, the function liquid supply apparatus further comprises a connection fitting having: a tube connecting portion connected to an upstream end of the connecting tube; and a connecting needle communicated with the tube connecting portion and connected to a supply port of the function liquid tank so as to connect the connecting tube and the function liquid tank together. The supply port is sealed with an elastic member for detachably receiving therethrough the connecting needle.

Such a configuration allows easy connection of the connecting tube to the function liquid tank by inserting the connecting needle of the connection fitting into the supply port of the function liquid tank through the elastic member. Furthermore, with such a configuration, the supply port is sealed with the elastic member, thereby preventing invasion of air (bubbles) at the time of insertion of the connecting needle, as well as preventing leakage of the function liquid from the tank at the time of replacement of the connecting needle.

According to another aspect of this invention, an imaging apparatus comprises: the above-described function liquid droplet ejection head and the above-described function liquid supply apparatus. The function liquid droplet ejection head is driven so as to eject function liquid droplets while performing a relative movement between the carriage and a work, whereby imaging is made on the work with the function liquid droplets.

According to this invention, the pressure adjustment valve and the function liquid tank are mounted on the carriage which performs relative movement between the carriage and the work, and accordingly, the pressure adjustment valve and the function liquid tank can be disposed within the region of the relative movement of the carriage. Furthermore, since the length of the connecting tube (function liquid flow passage) can be shortened, the function liquid can be stable supplied and also the function liquid droplet ejection head can be supplied with highly deaerated function liquid.

Preferably, the function liquid droplet ejection head, the pressure adjustment valve, and the function liquid tank, are disposed in a straight line.

According to this preferred embodiment, since the function liquid droplet ejection head, the pressure adjustment valve, and the function liquid tank are disposed in a straight line, the connecting tubes (function liquid flow passage) to connect them together can also be arranged in a straight line. As a result, the length of the function liquid flow passages can further be shortened.

Preferably, the pressure adjustment valve and the function liquid tank are disposed in a vertical posture.

According to this preferred embodiment, since the pressure adjustment valve and the function liquid tank are disposed in a vertical posture, the space, as seen in plan view, required for laying out the pressure adjustment valve and the function liquid tank can be restricted, resulting in an efficient laying them out on the carriage.

Preferably, the carriage has mounted thereon plural sets of units, each unit having the function liquid droplet ejection head, the pressure adjustment valve, and the function liquid tank disposed in a straight line.

According to this preferred embodiment, the length of the function liquid flow passage in each of the units can be minimized, thereby enabling stable supply of the function liquid to the function liquid droplet ejection head in each unit.

Preferably, the plural sets of units are arrayed in a direction orthogonal to the direction in which the function liquid droplet ejection head, the pressure adjustment valve, and the function liquid tank are disposed in a straight line substantially in a side by side relationship. The plurality of function liquid droplet ejection heads contained in the plural sets of units forming the plurality of units are mounted on the carriage in a state of being positioned and fixed to a single head plate.

According to this preferred embodiment, the plurality of function liquid droplet ejection heads are arranged to form a single unit on the head plate. Therefore, each of the function liquid droplet ejection heads can be accurately positioned and mounted on the carriage. Further, the plurality of function liquid droplet ejection heads can be efficiently mounted on the carriage.

Preferably, the plurality of pressure adjustment valves contained in the plural sets of units are mounted on the carriage in a state of being positioned and fixed to a single valve plate.

According to this preferred embodiment, the plurality of pressure adjustment valves can be made into a unit by a single valve plate in a state of being aligned in position. Therefore, the workability of mounting the plurality of pressure adjustment valves onto the carriage can be improved.

Preferably, the plurality of function liquid tanks contained in the plural sets of units are mounted on the carriage in a state of being positioned and fixed to a single tank plate.

According to this preferred embodiment, the plurality of function liquid tanks are positioned and fixed to the carriage. Therefore, they can be efficiently mounted on the carriage.

In a method of manufacturing an electro-optical device according this invention, a film is formed of the function liquid droplets on the work with the above-described imaging apparatus. In an electro-optical device according to this invention, a film is formed of the function liquid droplets on the work with the above-described imaging apparatus.

According to the above preferred embodiments, an electro-optical device can be manufactured using the imaging apparatus which is capable of accurately imaging on the work, by stably supplying the function liquid droplet ejection heads with highly deaerated function liquid, thereby resulting in efficient manufacturing thereof. Examples of the electro-optical devices include: a liquid-crystal display device; an organic electro-luminescence (EL) device; an electron emission device; a plasma display panel (PDP) device; an electrophoresis display device; and so forth. Examples of the above-described electron emission device is a concept including a so-called field emission display (FED) device and a surface-conduction electron-emitter display (SED) device. Examples of electro-optical device include devices for forming metal wiring, forming lenses, forming a resist, forming a light diffuser, and so forth.

An electronic device according to this invention has mounted thereon an electro-optical device manufactured by the above-described method of manufacturing an electro-optical device, or has mounted thereon an electro-optical device having formed on a work a film of the function liquid droplets using the above-described imaging apparatus.

Examples of the electronic device includes: a cellular phone having mounted thereon a so-called flat panel display; a personal computer; and various kinds electric devices.

### BRIEF DESCRIPTION OF THE DRAWINGS

The above and other objects and the attendant features of this invention will become readily apparent by reference to the following detailed description when considered in conjunction with the accompanying drawings wherein:

FIG. 1 is a schematic plan view of the imaging apparatus according to an embodiment of this invention;

FIG. 2 is a schematic front view of the imaging apparatus according to the embodiment of this invention;

FIG. 3 is a schematic plan view of the supporting frame;

FIG. 4 is a perspective external view showing the function liquid droplet ejection head;

FIG. 5 is an explanatory diagram showing the function liquid tank and thereabout;

FIG. 6 is an external perspective view showing the pressure adjustment valve as viewed from the rear side thereof;

FIGS. 7A and 7B are explanatory views of the pressure adjustment valve, wherein FIG. 7A is a rear view of the pressure adjustment valve, and FIG. 7B is a front view thereof;

FIGS. 8A and 8B are explanatory views of the pressure adjustment valve, wherein FIG. 8A is a longitudinal cross-sectional view of the pressure adjustment valve, and FIG. 8B is an enlarged longitudinal cross-sectional view of a primary chamber;

FIG. 9 is an explanatory view showing the operation of the pressure adjustment valve;

FIG. 10 is a schematic view showing the relationship in height between the function liquid droplet ejection head, the pressure adjustment valve, and the function liquid tank;

FIG. 11 is a block diagram showing the main control system of the imaging apparatus;

FIG. 12 is a flowchart showing the manufacturing process for manufacturing a color filter;

FIGS. 13A through 13E are schematic cross-sectional views each showing the color filter in the order of the manufacturing steps;

FIG. 14 is a schematic cross-sectional view showing a schematic configuration of the liquid crystal device employing the color filter according to this invention;

FIG. 15 is a schematic cross-sectional view showing a schematic configuration of a second example of the liquid crystal device employing the color filter according to this invention;

FIG. 16 is an exploded view showing a schematic configuration of a third example of the liquid crystal device employing the color filter according to this invention;

FIG. 17 is a schematic cross-sectional view of a main portion of the display device constituting an organic EL device;

FIG. 18 is a flowchart showing the manufacturing process for manufacturing the display device constituting the organic EL device;

FIG. 19 is a schematic cross-sectional view showing the formation of an inorganic bank layer;

FIG. 20 is a schematic cross-sectional view showing the formation of the organic bank layer;

FIG. 21 is a schematic cross-sectional view showing the formation of a hole injection/transporting layer;

FIG. 22 is a schematic cross-sectional view showing the state in which the hole injection/transporting layer has been formed;

FIG. 23 is a schematic cross-sectional view showing the formation of an emitting layer for blue color;

FIG. 24 is a schematic cross-sectional view showing the state in which the emitting layer for blue has been formed;

FIG. 25 is a schematic cross-sectional view showing the state in which emitting layers of respective colors of red, green and blue have been formed;

FIG. 26 is a schematic cross-sectional view showing the formation of a cathode;

FIG. 27 is a schematic exploded perspective view showing the display device constituting a plasma display panel device (PDP device);

FIG. 28 is a schematic cross-sectional view of a main portion showing the display device constituting an electron emission device (FED device); and

FIG. 29A is a schematic plan view showing the electron emission portion and thereabout of the display device, and FIG. 29B is a plan view showing the formation thereof

### DETAILED DESCRIPTION OF THE PREFERRED EMBODIMENTS

Description will now be made below about an imaging apparatus according to this invention with reference to the accompanying drawings. The imaging apparatus is built (or assembled) in a line of manufacturing so-called flat displays in a liquid droplet ejection method using function liquid droplet ejection heads. The imaging apparatus is used therein to form emitting elements which serve as pixels for color filters of a liquid crystal display device, for an organic electro-luminescence device, or the like.

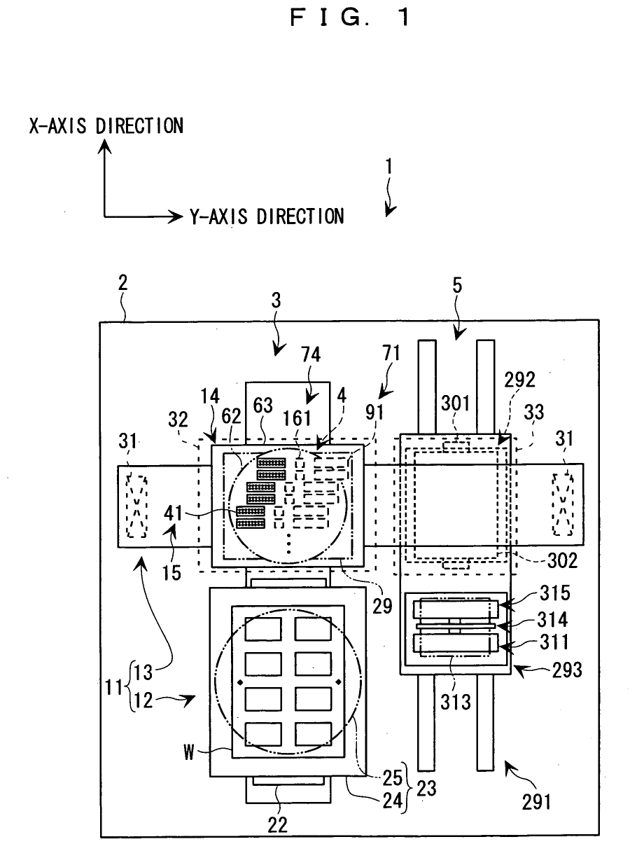

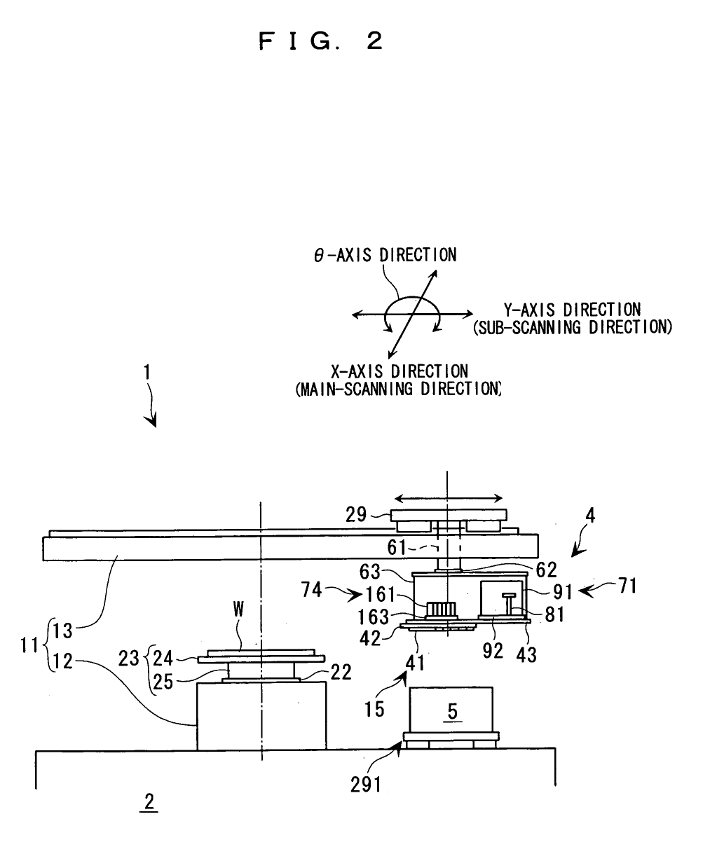

As shown in FIGS. 1 and 2, the imaging apparatus 1 is made up of: an apparatus base 2; a liquid droplet ejection apparatus 3 which is provided with function liquid droplet ejection heads 41 and which is mounted on the entire region of the apparatus base 2; a function liquid supply apparatus 4 which is connected to the liquid droplet ejection apparatus 3; and a head maintenance apparatus 5 which is mounted on the apparatus base 2 in close proximity to the liquid droplet ejection apparatus 3. Furthermore, the imaging apparatus 1 has a control apparatus 6 (not illustrated). With the imaging apparatus 1 having such a configuration, the liquid droplet ejection apparatus 3 images (draws images) on the work W according to instructions from the control apparatus 6 while the liquid droplet ejection apparatus 3 receives supply of the function liquid from the function liquid supply apparatus 4. At the same time, the head maintenance apparatus 5 performs maintenance of the function liquid droplet ejection head 41, as required.

The liquid droplet ejection apparatus 3 is made up of an X-Y positioning (moving) mechanism 11 formed of an X-axis table 12 for main-scanning (moving in the X-axis direction) of the work W and a Y-axis table 13 orthogonal to the X-axis table 12; a main carriage 14 which is mounted on the Y-axis table 13 in a movable manner; and a head unit 15 which is disposed to suspend in a vertical direction so as to mount thereon the function liquid droplet ejection head 41.

The X-axis table 12 includes an X-axis slider 22 driven by an X-axis motor (not illustrated) serving as a driving system in the X-axis direction. A set table 23 including a suction table 24, a θ table 25, or the like, is mounted on the X-axis slider 22, thereby allowing positioning of the set table 23. On the other hand, the Y-axis table 13 includes a Y-axis slider 29 driven by a Y-axis motor (not illustrated) serving as a driving system in the Y-axis direction. The main carriage 14 supporting the head unit 15 is mounted on the Y-axis slider 29, thereby allowing positioning of the main carriage 14 in the Y-axis direction. The X-axis table 12 is disposed in parallel with the X-axis direction, and is directly supported by the apparatus base 2. On the other hand, the Y-axis table 13 is supported by left and right supporting columns 31 erected on the apparatus base 2. The Y-axis table 13 extends in the Y-axis direction in the form of a bridge over the X-axis table 12 and the head maintenance apparatus 5 (see FIGS. 1 and 2).

In the imaging apparatus 1, the area where the X-axis table 12 and the Y-axis table 13 cross each other serves as an imaging area 32 for imaging on the work W, and the area where the Y-axis table 13 and the head maintenance apparatus 5 cross each other serves as a maintenance area 33 for performing function-recovery processing for the function liquid droplet ejection heads 41. With such a configuration, at the time of imaging on the work W, the head unit. 15 is positioned in the imaging area 32. On the other hand, at the time of function-recovery processing, the head unit 15 is positioned in the maintenance area 33.

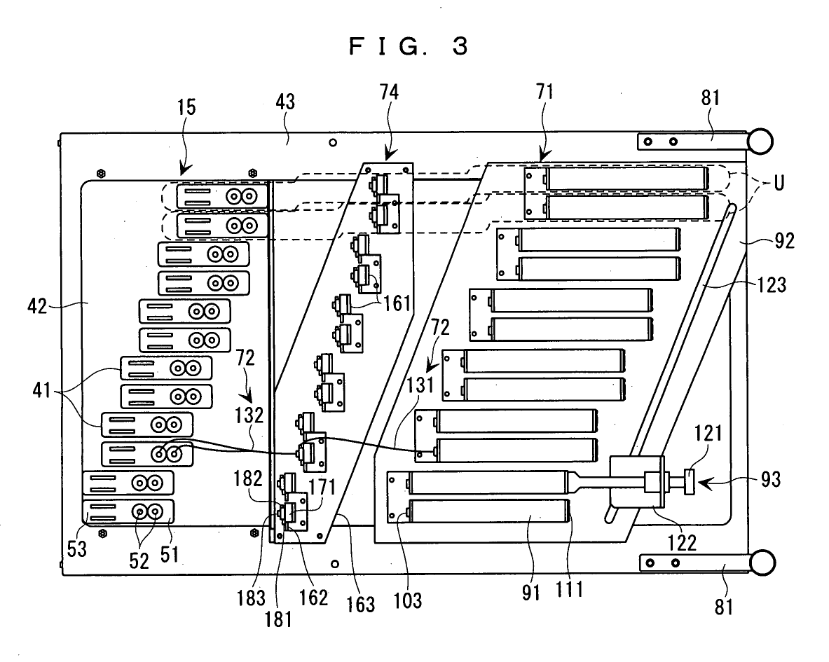

The head unit 15 includes a plurality of (twelve) function liquid droplet ejection heads 41 and a head plate 42 which mounts thereon the function liquid droplet ejection heads 41 through a head holding member (not illustrated). The head plate 42 is detachably supported by a supporting frame 43, and the head unit 15 is mounted after due alignment on the main carriage 14 through the supporting frame 43. A valve unit 74 and a tank unit 71 for the function liquid supply apparatus 4 are further mounted on the supporting frame 43 in close proximity to the head unit 15 (see FIGS. 1 and 3).

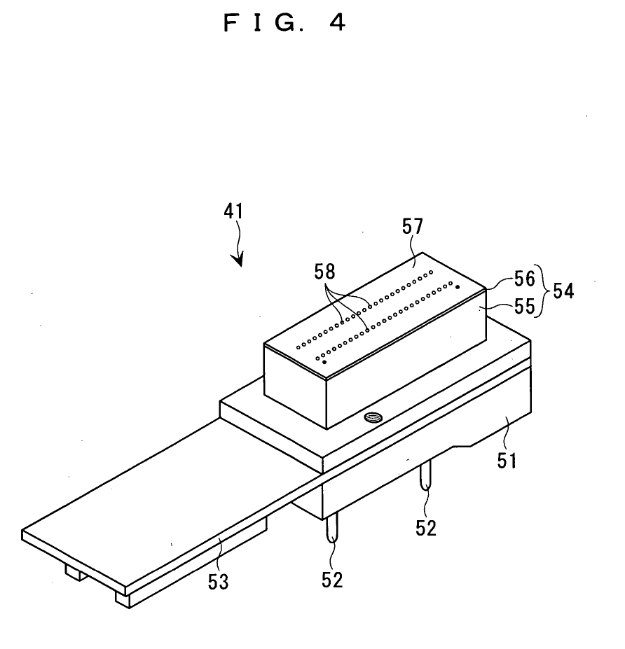

As shown in FIG. 4, the function liquid droplet ejection head 41 is of a so-called double-row construction, and is provided with: a function liquid introduction portion 51 having double-row connecting needles 52; double-row head bases 53 communicated with the function liquid introduction portion 51; and a head main body 54 having a flow passage inside the head and which is filled with the function liquid. The head main body 54 is in communication with the lower part of the function liquid introduction portion 51. The connecting needles 52 are connected to the function liquid supply apparatus 4 (not illustrated) for supplying the flow passage inside the head main body with the function liquid. The head main body 54 comprises a cavity 55 (piezoelectric element) and a nozzle plate 56 having a nozzle face 57 including ejection nozzles 58 in the form of openings. The nozzle face 57 includes nozzle arrays formed of a multiplicity of (180) ejection nozzles 58. Upon driving the function liquid droplet ejection head 41 so as to eject the function liquid, the function liquid droplets are ejected from the ejection nozzles 58 by pumping action of the cavity 55.

The head plate 42 is formed of a rectangular plate with a predetermined thickness formed of stainless steel, or the like. The head plate 42 includes twelve mounting openings (not illustrated) each of which is used for positioning and mounting the corresponding function liquid droplet ejection head 41. Each of the twelve function liquid heads 41 is mounted from the back of the head plate 42 and are fixed through the head holding member. The twelve mounting openings are divided into six pairs, each having two. The six pairs of mounting openings are arrayed in the direction orthogonal to the nozzle-array direction with predetermined offset between the adjacent pairs of mounting openings in the nozzle-array direction. The nozzle arrays of the adjacent pairs overlap with each other in the nozzle-array direction. Namely, the twelve function liquid droplet ejection heads 41 are divided into six pairs, and arrayed in the direction orthogonal to the nozzle-array direction in a stepped manner; the nozzle arrays of the adjacent pairs overlapping with each other in the nozzle-array direction (see FIG. 3).

The multiplicity (180) of ejection nozzles 58 are arrayed at a pitch of four dots on each function liquid droplet ejection head 41 in the form of a pair of the nozzle arrays. In this case, the two nozzle arrays forming a pair are arrayed with offset of two dots therebetween in the array direction. Namely, each function liquid droplet ejection head 41 has a function of imaging a line formed of dots arrayed at a pitch of two dots by action of a pair of nozzle arrays. On the other hand, the adjacent two function liquid droplet ejection heads 41 forming a pair are arrayed such that the two lines formed of dots arrayed at a pitch of two dots, each of which is imaged by the adjacent two function liquid droplet ejection heads 41, are arrayed with offset of one dot therebetween, whereby a pair of function liquid droplet ejection heads 41 have a function of imaging a line at a pitch of one dot. Namely, each function liquid droplet ejection head 41 includes a pair of nozzle arrays each of which has quarter the resolution of full performance. The pair of nozzle arrays are arrayed with predetermined offset therebetween such that the function liquid droplet ejection head 41 exhibits half the resolution of the full performance. Furthermore, the two function liquid droplet ejection heads 41 forming a pair are arrayed with predetermined offset, whereby the pair of function liquid droplet ejection heads 41 exhibit the same resolution as full performance. Other ten function liquid droplet ejection heads 41 (forming five pairs) have the same configuration, and are arrayed in the same way.

As shown in FIG. 2, the main carriage 14 is made up of an I-shaped suspension member 61 which is fixed to the Y-axis table 13 from the lower side thereof, a θ-angle adjustment mechanism 62 which is attached to the lower face of the suspension member 61 for adjusting the angle in the θ direction (of the head unit 15); a carriage main body 63 mounted underneath the θ-angle adjustment mechanism 62 so as to be suspended therefrom. The carriage main body 63 supports the head unit 15 through the supporting frame 43. Furthermore, the carriage main body 63 includes a rectangular opening (not illustrated) for fitting the supporting frame 43 with some play, as well as a positioning mechanism (not illustrated) for positioning of the supporting frame 43. It is thus so arranged that the head unit 15 can be fixed in a state of being aligned.

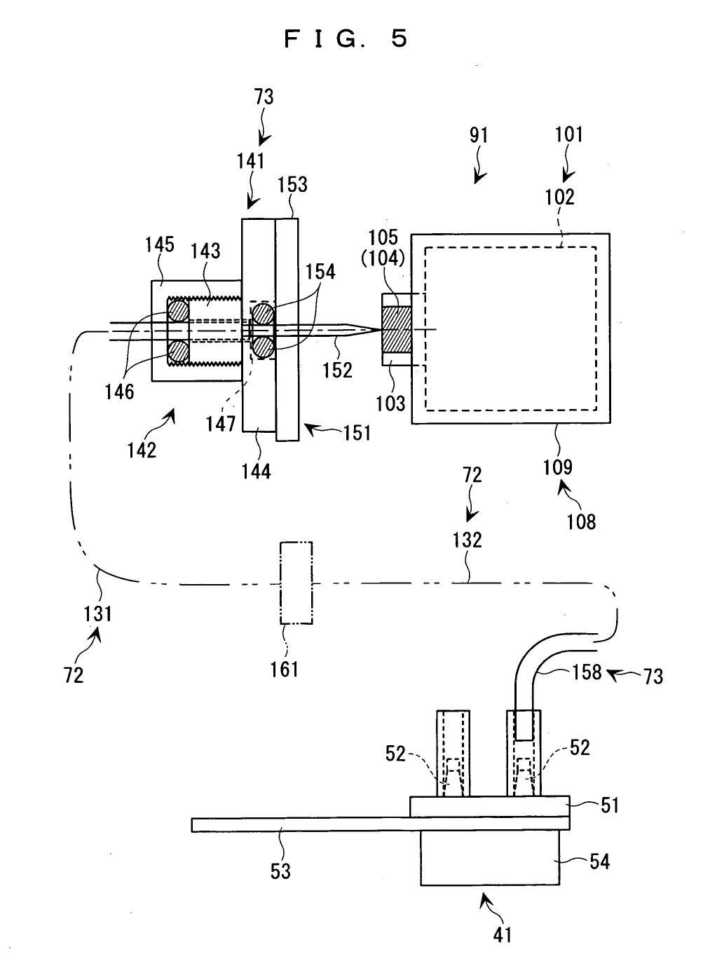

As shown in FIGS. 1 through 3, the function liquid supply apparatus 4 is mounted on the above-described supporting frame 43 together with the head unit 15. The function liquid supply apparatus 4 is made up of a tank unit 71 having a plurality of (twelve) function liquid tanks for storing therein the function liquid; a plurality of (twelve) function liquid supply tubes 72 for connecting the function liquid tanks 91 and the corresponding function liquid droplet ejection heads 41, respectively; a plurality of (twelve) connection fittings 73 (see FIG. 5) for connecting the function liquid supply tubes 72 to the corresponding function liquid tanks 91 and to the corresponding function liquid droplet ejection heads 41, respectively; and a plurality of (twelve) pressure adjustment valves 161 respectively interposed in the plurality of function liquid supply tubes 72.

As shown in FIG. 3, the supporting frame 43 is formed generally in the shape of a rectangular frame. The head unit 15, the valve unit 74, and the tank unit 71 are mounted in the order mentioned in the longitudinal direction of the supporting frame 43. Furthermore, the supporting frame 43 includes an opening (not illustrated) for fitting and mounting the head unit 15 from the lower side thereof with some play, as well as a head positioning mechanism (not illustrated) for positioning (or aligning) the head unit 15 (head plate 42). The head positioning mechanism includes three positioning pins (not illustrated) protruding downward from the supporting frame 43. By bringing these three positioning pins into abutment with the end surfaces of the head plate 42, the head unit loosely fit into the opening can be mounted at high accuracy in a state in which the long-side direction of the head unit 15 and the short-side direction of the supporting frame 43 are made to coincide with each other. The supporting frame 43 has a pair of handles 81 along the longitudinal direction thereof to facilitate mounting and dismounting of the supporting frame 43 on and from the main carriage 14 (carriage main body 63).

The tank unit 71 is made up of the twelve function liquid tanks 91; a tank plate 92 which has twelve setting portions 111 for positioning the function liquid tanks 91; a tank setting jig 93 for mounting (setting) the function liquid tanks 91 on the corresponding setting portions 111. As shown in FIG. 5, the function liquid tank 91 is of a cartridge type and has a function liquid pack 101 containing therein the vacuum-packed function liquid, and a resin cartridge casing 108 for housing (or storing) therein the function liquid pack 101. The function liquid to be stored in the function liquid pack 101 is deaerated beforehand, i.e., the function liquid is stored in the function liquid pack 101 substantially free of dissolved gas.

The function liquid pack 101 comprises a bag formed of a pair of rectangular (flexible) film sheets 102 overlaid and thermally adhered together, and a resin supply port 103 for supplying the function liquid. The function liquid pack 101 exhibits sufficient flexibility for changing the shape thereof to a flat one as a result of decrease in the function liquid stored therein, thereby allowing the user to use up the function liquid pack 101 to the last drop. The supply port 103 includes a communication opening 104 for communicating with the inside of the function liquid pack 101. The communication opening 104 is closed with a seal member 105 formed of an elastic material having corrosion resistance to the function liquid, such as butyl rubber, or the like, thereby preventing invasion of air (oxygen) or moisture from the communication opening 104. In order to prevent the function liquid stored inside the function liquid pack 101 from getting deteriorated, there is used the film sheet 102 having a laminated structure in which are laminated a plurality of material sheets having various properties such as corrosion resistance to the function liquid, impermeability to gas, waterproofing, and so forth.

The cartridge casing 108 comprises a casing main body 109 formed in the shape of a flat box with one face open, and a lid (not illustrated) for covering the opening of the casing main body 109, whereby a storage spacing is formed in the inside thereof for storing the function liquid pack 101. The casing main body 109 includes an engaging portion (not illustrated) for engaging with the supply port 103 of the function liquid pack 101 with the supply port 103 protruding outward.

As shown in FIG. 3, the tank plate 92 is made of a thick plate of stainless steel, or the like, generally in the shape of a parallelogram. The tank plate 92 has twelve setting portions 111 which detachably set in position the function liquid tanks 91 in a vertical direction with the supply ports 103 thereof facing the valve unit 74. As shown therein, the layout of the setting portions 111 is made corresponding to the layout of the twelve function liquid droplet ejection heads 41 mounted on the head plate 42. Namely, the twelve function liquid tanks 91 are divided into six pairs thereof, and the above-described six pairs thus divided are arrayed in the short-side direction of the supporting frame 43 with the supply ports 103 thereof (the front side of the function liquid tank 91) facing the function liquid droplet ejection heads 41 and with predetermined offset between the adjacent pairs such that the supply ports 103 are arrayed along the long side of the tank plate 92. Note that “the function liquid tanks 91 are set in a vertical direction” means that the function liquid tanks 91 are positioned with the film sheets 102 of the function liquid pack 101 orthogonal to the tank plate 92. This way of setting has the advantage in that the function liquid tanks 91 can be mounted in a small area, as compared with the layout in which each of the function liquid tanks 91 is positioned in the horizontal direction, i.e., is positioned with the film sheets 102 of the function liquid pack 101 parallel to the tank plate 92.

The tank setting jig 93 is so arranged that, by pushing forward the rear side of the function liquid tank 91 (i.e., that face of the function liquid tank 91 which lies opposite to the front face thereof), the function liquid tank 91 slides forward, thereby setting in position the setting portion 111. The tank setting jig 93 is made up of a setting member 121 for pressing or pushing the function liquid tank 91, and a supporting member 122 for supporting the setting member 121. The tank plate 92 includes a guide opening 123 formed along the long side thereof facing the rear side of each function liquid tank 91. The supporting member 122 is thus allowed to slide on the tank plate 92 as guided by the guide opening 123. By moving the supporting member 122 so as to suit the setting position of each function liquid tank 91, the setting member 121 can be moved to face each function liquid tank 91 to thereby adequately set in position each function liquid tank 91.

As shown in FIG. 5, the function liquid supply tube 72 is made up of a tank-side tube 131 for connecting the corresponding function liquid tank 91 and the pressure adjustment valve 161; and a head-side tube 132 for connecting the corresponding pressure adjustment valve 161 and the function liquid droplet ejection head 41. The above-described tubes 131 and 132 have a layered or laminated structure having the properties such as corrosion resistance to the function liquid, impermeability to gas, waterproofing, and so forth, in the same way as in the above-described function liquid pack 101. For example, in case a water-based function liquid is used, a tube having a five-layer structure is employed in which a polyethylene layer, an adhesive-agent layer, an ethylene-vinylalcohol copolymer layer, an adhesive-agent layer, and a polyethylene layer are laminated in the order described from the inside to the outside. On the other hand, in case a solvent-based function liquid is used, a tube having a three-layer structure is employed in which an ethylene-vinylalcohol copolymer layer, an adhesive-agent layer, and a polyethylene layer are laminated in the order described from the inside to the outside. Polyethylene is a material which exhibits waterproofing properties, and the ethylene-vinylalcohol copolymer is a material which exhibits impermeability to gas.

The connection fitting 73 is made up of a tank-side adapter 141 for connecting the function liquid tank 91 and one end of the function liquid supply tube 72; and a head-side adapter 158 for connecting the function liquid droplet ejection head 41 and the other end of the function liquid supply tube 72. The tank-side adapter 141 has a tube connecting portion 142 to be directly connected to the above-described one end of the function liquid supply tube 72, and a tank connecting portion 151 to be connected to the function liquid tank 91. Each of the connecting portions 142 and 151 has formed therein a function liquid flow passage for supplying the function liquid from the function liquid tank 91.

The tube connecting portion 142 is made up of a cylindrical male screw 143 for screwing the function liquid supply tube 72 into the axial center thereof, a tube-side flange 144 for supporting the cylindrical male screw 143; a female-screw cap 145 into which the cylindrical male screw 143 is screwed; and a tube-side O-ring 146 which is interposed between the cylindrical male screw 143 and the female-screw cap 145 in order to keep the function liquid supply tube 72 in a manner tightly sealed against leaking of liquid. On the other hand, the tank connecting portion 151 is made up of a connecting needle 152 having formed a flow passage along the axial center thereof, a tank-side flange 153 for holding the connecting needle 152; and a tank-side O-ring 154 which is interposed in a connecting-needle fitting groove 147 in the tube-side flange 144. The tube connecting portion 142 is connected to the tank connecting portion 151 by fitting the tube-side flange 144 to the tank-side flange 153. Here, the above-described O-rings 146 and 154 are preferably formed of a material having corrosion resistance to the function liquid, impermeability to gas, waterproofing, and so forth, such as butyl rubber, or the like.

The connecting needle 152 has a sharp tip having a plurality of minute inflow or inlet openings (not illustrated) each of which communicates with the inner flow passage thereof Namely, the connecting needle 152 is inserted into the function liquid pack 101 through the seal member 105 (communication opening 104) of the above-described function liquid pack 101 so as to be connected to the function liquid pack 101. The function liquid is thus allowed to flow from the function liquid pack 101. In addition, the base of the connecting needle 152 is inserted into the function liquid supply tube 72, whereby the above-described inner flow passage is connected to the flow passage of the function liquid supply tube 72.

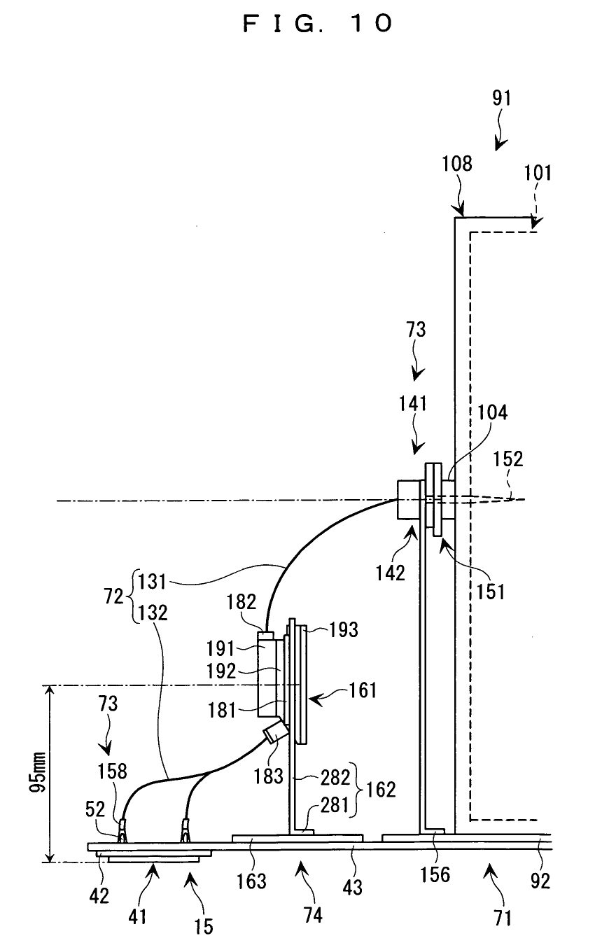

The twelve tank-side adapters 141 are supported, in an aligned state, by a plurality of L-shaped adapter fixing members 156 each of which is bent into an L-shape and is fixed to the tank plate 92. When the function liquid tanks 91 are completely set in position (or mounted) on the setting portion 111, the connecting needle 152 of the tank-side adapter 141 is connected to the communication opening 104 of the corresponding function liquid tank 91 (see FIG. 10).

The head-side adapter 158 is formed into a short cylindrical shape of butyl rubber. The function liquid supply tube 72 is inserted into the upper half portion of the head-side adapter 158, and the connecting needle 52 of the function liquid droplet ejection head 41 is inserted into the lower half portion thereof.

The valve unit 74 is made up of: the twelve pressure adjustment valves 161; twelve valve supporting members 162 for supporting the above-described twelve pressure adjustment valves; and a valve plate 163 for supporting the twelve pressure adjustment valves 161 through the valve supporting members 162 (see FIG. 3).

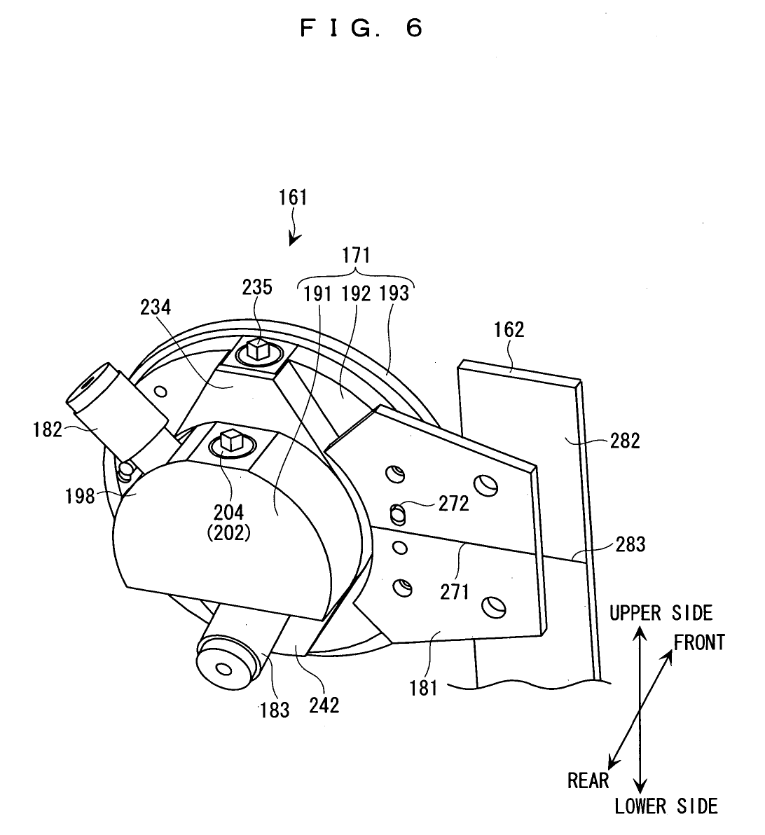

As shown in FIG. 6 through FIGS. 8A and 8B, the pressure adjustment valve 161 is constructed by forming inside a valve housing 171: a primary chamber 172 which is in communication with the function liquid tank 91; a secondary chamber 173 which is in communication with the function liquid droplet ejection head 41; and a communication flow passage 174 which allows communication between the primary chamber 172 and the secondary chamber 173. On one face of the secondary chamber 173 there is provided a diaphragm 175 so as to face the outside. Furthermore, the communication flow passage 174 includes a valve body 176 having a function of open/close operation performed by action of the diaphragm 175. The function liquid introduced into the primary chamber 172 from the function liquid tank 91 is supplied to the function liquid droplet ejection head 41 through the secondary chamber 173. In this case, open/close operation of the valve body 176 disposed in the communication flow passage 174 is controlled by action of the diaphragm 175 with the atmospheric pressure as a reference adjustment pressure, thereby enabling adjustment of the pressure in the secondary chamber 173.

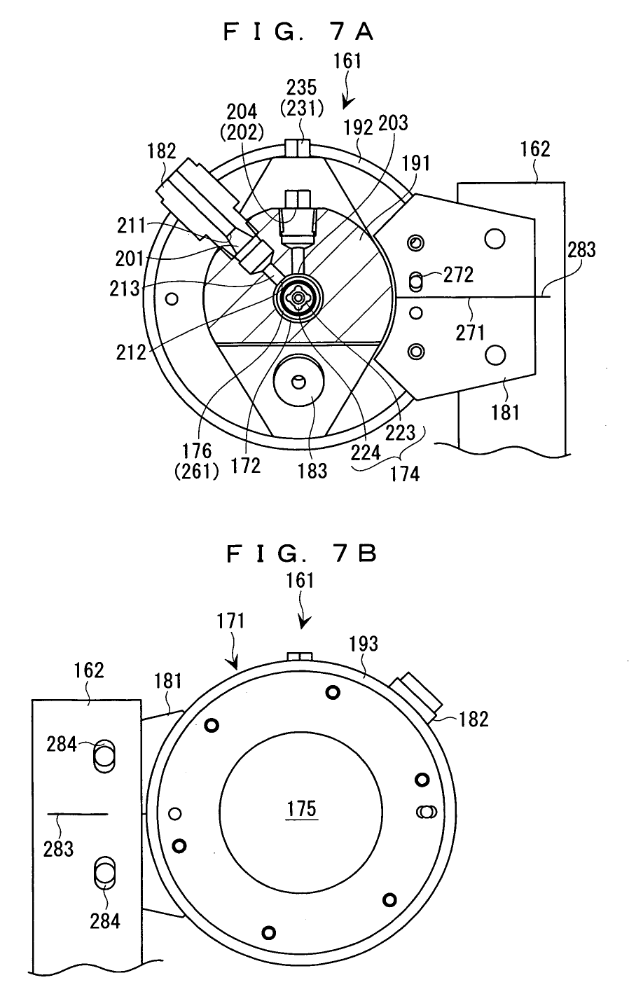

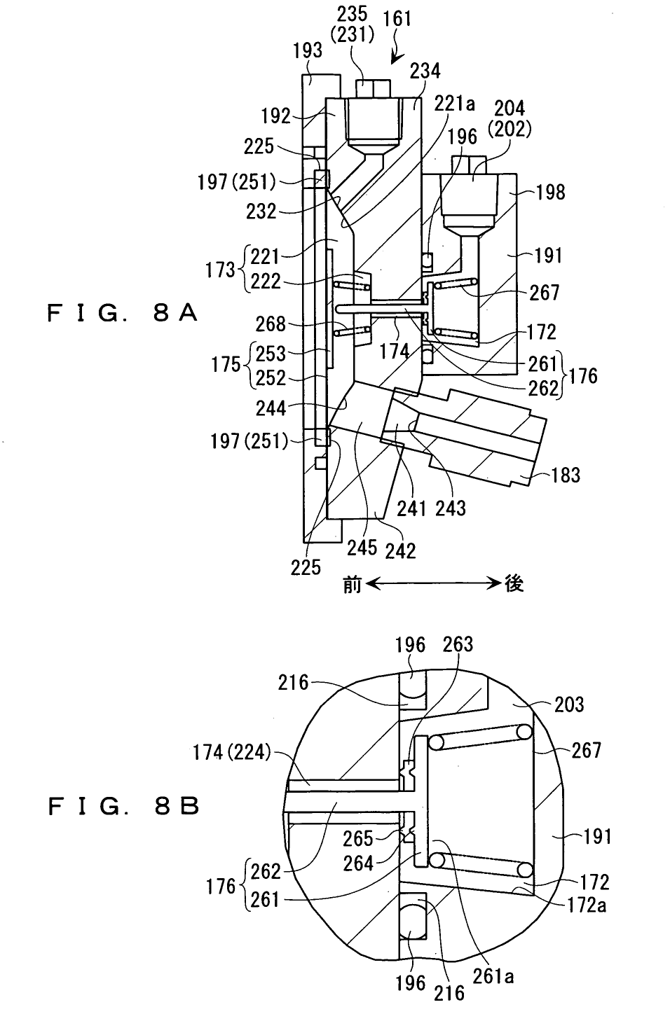

As shown in FIG. 6 through FIGS. 8A and 8B, the pressure adjustment valve 161 is positioned in an upright posture with the diaphragm 175 being disposed vertically. Accordingly, the “upper side”, the “lower side”, the “front side” and the “rear side” are designated as shown by respective arrows in FIGS. 6, 8A and 8B. FIGS. 6, 7A and 7B show a state in which the pressure adjustment valve 161 has attached thereto a mounting plate 181 for mounting the pressure adjustment valve 161 on a frame, or the like (the valve supporting member 162 in this embodiment), an inlet (or inflow) connector 182 (union coupling) for coupling the above-described tank-side tube 131, and an outlet (or outflow) connector 183 (union coupling) for coupling the above-described head-side tube.

The valve housing 171 is made up of he following three members, i.e.: a primary chamber housing 191 which has formed therein the primary chamber 172; a secondary chamber housing 192 which has formed therein the secondary chamber 173 and which is formed slightly larger in size than the primary chamber housing 191; and a ring plate 193 which fixes the diaphragm 175 to the secondary chamber housing 192. Each of the above-described members is formed of a corrosion-resisting material such as stainless steel, or the like. The primary chamber housing 191, the secondary chamber housing 192, and the ring plate 193 are assembled by sandwiching the secondary chamber housing 192 with the ring plate 193 and the primary chamber housing 191. They are then aligned by means of a plurality of stepped parallel pins, or the like, and are finally fixed with screws. With such a sandwiched structure, each component is positioned coaxially with the axial line passing through the center of the circular diaphragm 175. Furthermore, the primary chamber hosing 191 and the secondary chamber housing 192 are hermetically connected together by bringing them into abutment with each other with an O-ring 196 interposed therebetween. The secondary chamber housing 192 and the ring plate 193 are hermetically brought into abutment with each other with the edge portion of the diaphragm 175 and a packing 197 interposed therebetween. An arrangement may be made so that the primary chamber housing 191 and the secondary chamber housing 192 are integrally formed.

In the primary chamber housing 191 the primary chamber 172 is formed in the shape of a truncated cone (generally in the shape of a cylinder) coaxially with the diaphragm. The inner wall 172a of the primary chamber 172 is slightly tapered so as to expand toward the rear side. Furthermore, the primary chamber housing 191 includes an upper boss portion 198 formed on the upper portion of the rear face of the primary chamber housing 191. The upper boss portion 198 includes an inlet port 201 communicating with the function liquid tank 91 and a primary-chamber air-release port 202. The primary-chamber air-release port 202 is formed so as to extend in the vertical direction. Furthermore, a primary-chamber air-release opening 203 is formed in that corner of the rear side of the inner face of the primary chamber 172 which serves as an air trap. Description is being made with reference to the drawings about an arrangement in which a blind cap 204 is screwed into the primary-chamber air-release port 202. In case air tube is connected to the primary-chamber air-release port 202, a connector (coupling) is screwed instead of the above-described blind cap 204.

The inlet port 201 is made up of an inlet opening 211 formed on the outer circumference of the primary chamber housing 191; a primary-chamber-side opening 212 formed on the upper end of the primary chamber 172; and an inlet flow passage 213 communicating with the above-described openings. The inlet flow passage 213 is formed in the slant direction toward the circumference of the primary chamber housing 191 such that the function liquid flows with a predetermined down grade (see FIG. 7A). Furthermore, an inlet connector 182 is screwed into the inlet opening 211 along the axis of the inlet flow passage 213. The above-described tank-side tube 131 is connected to the inlet opening 211 through the inlet connector 182. The inner flow passage in the inlet connector 182 is formed so as to gradually expand toward the downstream end without steps, thereby preventing rapid change in the flow speed of the function liquid. On the other hand, the primary-chamber-side opening 212 is formed in a portion adjacent to the above-described primary-chamber air-release opening 203, i.e., in a portion on the inner circumference of the primary-chamber with predetermined offset from the edge thereof. The function liquid flows downward from the function liquid tank 91 along the inlet flow passage 213 formed with a predetermined down grade, and flows into the primary chamber 172 from the primary-chamber-side opening 212 along the inner wall 172a of the primary chamber 172.

The front face of the primary chamber housing 191 in close contact with the secondary chamber housing 192 includes a first annular groove 216 having a rectangular cross-sectional shape, so as to face the outside of the primary chamber 172. Furthermore, the above-described O-ring 196 is fit to the first annular groove. On the other hand, the lower portion of the primary chamber housing 191 is truncated, whereby the primary chamber housing 191 is formed in the shape of a semicircle. The outflow connector 183 is disposed in the above-described truncated portion.

As shown in FIGS. 8A and 8B, the secondary chamber housing 192 is made up of: a main chamber 221 formed in the shape of a truncated cone (generally in the shape of a cylinder) having an open face for mounting the diaphragm 175; a spring chamber 222 which is communicated with the rear of the main chamber 221 and which is formed in the shape of a truncated cone (generally in the shape of a cylinder) so as to expand toward the main chamber; and the communication flow passage 174 which allows communication between the spring chamber 222 and the primary chamber 172. Here, the main chamber 221, the spring chamber 222, and the communication flow passage 174 are formed in the cross-sectional shape of a circle concentric with the diaphragm 175. The communication flow passage 174 is formed of a shaft inserting portion 223 having a circular cross-sectional shape for slidably fitting a shaft 262 of the valve body 176 (described later), and a flow-path portion 224 having a cross-sectional shape of a cross extending in the radial direction from the shaft inserting portion 223 (see FIG. 7A). The secondary chamber housing 192 includes an annular shallow groove 225 formed on the front face thereof for fitting the packing 197 (described later).

The inner wall 221a of the main chamber 221 is tapered to greatly expand toward the front side so as to follow (cope with) the deformation of the diaphragm 175 in the rear-side direction. A secondary-chamber air-release port 231 and an outflow port 241 are formed in the upper portion and the lower portion, respectively, so as to open into the tapered face. The secondary-chamber air-release port 231 is formed in an upper boss portion 234 formed in the upper portion of the rear face of the secondary chamber housing 192, extending in the vertical direction with some slant. A secondary-chamber air-release opening 232 of the secondary-chamber air-release port 231 is formed in a corner including that tapered face of the inner face of the front portion of the secondary chamber 173 which serves as an air pocket. Description is being made with reference to the drawings about an arrangement in which a blind cap 235 is screwed into the secondary-chamber air-release port 231. An arrangement may also be made such that an air tube is connected to the secondary-chamber air-release port 231 through a connector (joint) instead of the blind cap 235.

The outflow port 241 is formed in a slant boss portion 242 positioned at the lower portion of the rear face of the secondary chamber housing 192. The outflow port 241 is made up of: an outflow opening 243 formed in the lower portion of the rear face of the secondary chamber housing 192; a secondary-chamber-side opening 244 formed on the lower end of the secondary chamber 173; and an outflow flow passage 245 which allows these openings to communicate with each other. The outflow flow passage 245 is formed so as to extend in a slightly downward direction, relative to the horizontal direction as seen in the figure, orthogonal to the tapered face of the secondary chamber 173. The outflow connector 183 has a screwed connection to the outflow opening 243 in the axial direction of the flow passage. The above-described head-side tube 132 is connected through the outflow connector 183. The inner flow passage formed within the inlet connector 183 is formed so as to gradually expand toward the upstream end without steps, thereby preventing rapid change in the flow speed of the function liquid. The secondary-chamber-side opening 244 is formed on the taper face including the corner of the secondary chamber 173 with generally the same width as with the taper face. With such a configuration, the function liquid in the secondary chamber 173 flows from the secondary-chamber-side opening 244 through the outflow flow passage 245 formed with a predetermined down grade, whereby the function liquid flows toward the function liquid droplet ejection head 41.

On the other hand, the diaphragm 175 is fixed between the front face of the secondary chamber housing 192 and the ring plate 193. The ring plate 193 includes a fixing groove 251 formed on the face thereof facing the secondary chamber, for fitting the packing 197 pressed into contact with the edge of the diaphragm 175. Description has so far been made about an arrangement according to this embodiment in which the ring plate 193 is pressed into contact with the secondary chamber housing 192 through the packing 197 between the above-described shallow groove 225 and fixing groove 251. However, it is not always necessary to form the shallow groove 225 in the secondary chamber housing 192 because the packing is elastic.

The diaphragm 175 is made up of a diaphragm main body 252 formed of a resin film, and a pressure-receiving plate 253 formed of resin, which is bonded to the inner side of the diaphragm main body 252. The pressure-receiving plate 253 is formed with a sufficiently small diameter as compared with the diaphragm main body 252, and is positioned coaxially with the diaphragm main body 252. The shaft 262 of the valve body 176 is brought into contact with the center of the pressure-receiving plate 253. The diaphragm main body 252 has a laminated (multi-layered) structure in which a heat-resistant polypropylene (PP) film, a special PP film, and a polyethylene terephthalate (PET) film with vapor-deposited silica are laminated, and is formed with the same diameter as with the front face of the secondary chamber housing 192. The diaphragm 175 is hermetically fixed to the front face of the secondary chamber housing 192 with the ring plate. 193 through the packing 197 which is positioned along the outer circumference of the diaphragm 175. An arrangement may be made in which the pressure-receiving plate 253 is provided on the face of the diaphragm 175 on the outside of the secondary chamber 173. However, in this embodiment, the pressure-receiving plate 253 is disposed on the face of the diaphragm 175 facing the secondary chamber 173 to prevent damages to the diaphragm main body 252 due to the movement of the shaft 262 of the valve body 176 into, and out of, contact with the pressure-receiving plate as described later.

The valve body 176 is made up of a circular valve main member 261; the shaft 262 extending from the center of the valve main member 261 in one direction in a manner to form a T-shaped cross section; and a ring-shaped valve seal 263 provided on (bonded to) the face of the valve main member 261 on the shaft (front) side of the valve main member 261. The valve main member 261 and the shaft 262 are integrally formed of a corrosion-resisting material such as stainless steel, or the like. Furthermore, the valve main member 261 has a small annular projection 264 formed on the face thereof on the side of the shaft 262. The valve seal 263 is formed of soft silicone rubber, or the like, and includes a circular sealing projection 265 formed on the front face thereof corresponding to the above-described small annular projection 264. With such a configuration, at the time of closing the valve body 176, the sealing projection 265 is pressed at high pressure into contact with that rear face of the secondary-chamber valve housing 171 which serves as a valve seat, i.e., the edge of the opening of the communication flow passage 174, whereby the communication flow passage 174 is hermetically sealed against the primary chamber. The valve main member 261 is formed in a size sufficiently smaller than the diaphragm 175, thereby enabling open/close operation of the valve body 176 corresponding to slight change in pressure in the secondary chamber 173 (see FIGS. 8A and 8B).

The shaft 262 is slidably and loosely fit into the communication flow passage 174, and the tip (front end) thereof comes into contact with the pressure-receiving plate 253 on the diaphragm 175 at the neutral position in the valve-closed state. Namely, at the time of positive deformation of the diaphragm 175 in which the diaphragm 175 inflates outward (to the left as seen in FIG. 8A), there occurs a predetermined gap between the front end of the shaft 262 and the pressure receiving plate 253. Then, upon negative deformation (i.e., to the right as seen in FIG. 8A) of the diaphragm 175 from the above-described state, the diaphragm 175 attains a neutral position in which the diaphragm 175 is positioned parallel to the ring plate 193. In this state, the front end of the shaft 262 is in contact with the pressure-receiving plate 253. If the diaphragm 175 further deforms in the negative direction, the pressure-receiving plate 253 presses or pushes the valve main member 261 through the shaft 262, whereby the valve is opened. Therefore, out of the entire volume of the secondary chamber 173, that amount of the function liquid which is equivalent to the volume attributable to the change in the diaphragm 175 from the positively deformed state to the neutral state, is supplied without receiving the pressure at all from the primary chamber.

On the other hand, a valve-body pressing spring 267 is disposed between the rear face 261a of the valve body 176 (valve main member 261) and the rear-side face wall of the primary chamber in order to press the valve body in the direction toward the secondary chamber, i.e., in the direction of closing the valve. Similarly, a receiving-plate pressing spring 268 is disposed between the pressure-receiving plate 253 and the spring chamber 222 in the secondary chamber in order to press the diaphragm main body 252 toward the outside through the pressure receiving plate 253. In this case, the valve-body pressing spring 267 assists the pressure applied to the rear face 261a of the valve body 176 due to the water head in the function liquid tank 91. Namely, the valve body 176 is pressed in the direction of closing the valve body 176, by the pressure due to the water head in the function liquid tank 91 and by the spring force of the valve-body pressing spring 267. On the other hand, the receiving-plate pressing spring 268 assists the deformation of the diaphragm 175 in the positive direction (i.e., to the left as seen in FIG. 8A). This spring 268 functions to make the secondary chamber slightly smaller in pressure than the atmospheric pressure (i.e., to a slightly negative pressure).

Although the details are given hereinafter, the pressure adjustment valve 161 is opened and closed by pressure balancing, as a result of forward and backward movement of the valve body 176, between the atmospheric pressure and the pressure in the secondary chamber 173 which is communicated with the function liquid droplet ejection head 41. At this time, the pressure is distributed between the valve-body pressing spring 267 and the receiving-plate pressing spring 268. Such operation enables extremely slow open/close operation of the valve body 176 in cooperation with the action of the valve seal 264 formed of soft silicone rubber having suitable elasticity. This suppresses rapid change in pressure (cavitation) due to rapid open/close operation of the valve body 176, thereby enabling the function liquid droplet ejection head 41 to eject the function liquid without cavitation. It is needless to say that pulsation of the flow due to the components on the side of the function liquid tank (on the side of the primary chamber) is also suppressed by action of the valve body 176, which allows separation of the primary chamber and the secondary chamber (damper function).

As shown in FIGS. 6, 7A, and 7B, the mounting plate 181 is formed of a stainless plate, and is fixed to the rear face of the side portion of the secondary chamber housing 192. The mounting plate 181 includes line marks 271 marked at a middle portion as seen in the vertical direction on both faces thereof for indicating the center position of the diaphragm 175. The marks 271 allow the user to easily and precisely mount the pressure adjustment valve 161 with a predetermined difference in height between the pressure adjustment valve 161 and the function liquid droplet ejection head 41 as described later. In the drawings, reference numeral 272 denotes a slot for positioning the marks 271 of the mounting plate 181 to the center position of the diaphragm 175. After positioning the mounting plate 181, the mounting plate 181 is fixed to the valve housing 171.

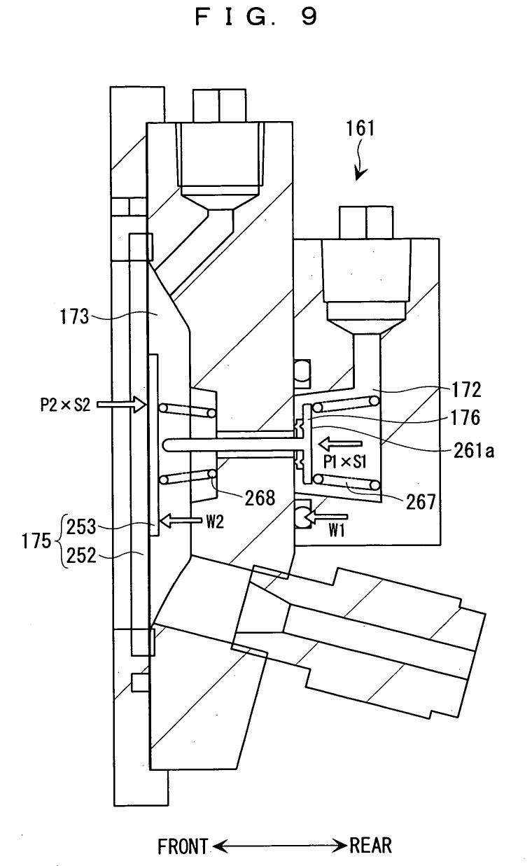

Next, description will be made about an operation mechanism of the pressure adjustment valve 161 with reference to FIG. 9. With such a configuration shown in FIG. 9, pressure is applied to the primary chamber 172 due to the water head of the function liquid stored in the function liquid tank 91 (more precisely, due to the difference in the water head between the center axis of the supply port of the function liquid pack 101 and the center axis of the primary chamber). In this case, the above-described pressure due to the water head and the spring force from the valve-body pressing spring 267 are applied to the valve body 176 in the direction of closing the valve.

Namely, let the pressure per unit area due to the water head be P1, let the area of the rear face 261a of the valve main member 261 be S1, and let the spring force of the valve-body pressing spring 267 be W1. Then, the force F1 applied to the valve body 176 in the direction from the primary chamber is given by
F1=(P1×S1)+W1
Here, W1 is a value taking into consideration the elasticity of the valve seal 263. Namely, W1 represents the total of the spring force and the force of elasticity (urging force) of the valve seal 263.

On the other hand, the force F2 which operates on the valve body 176 from the secondary-chamber side can be given by
F2=(P2×S2)−W2
where P2 is an internal pressure inside the secondary chamber 173, S2 is the center-diameter area of the diaphragm 175, and W2 is the spring force of the receiving-plate pressing spring 268. P1 and P2 represent gauge pressures. The center diameter D of the diaphragm 175 is represented by the average of the outer diameter of the diaphragm main body 252 and the outer diameter of the pressure-receiving plate 253 and, accordingly, S2 is given by
S2=(D/2)×(D/2)×π

With such a configuration including the valve body 176, in case F2 is greater than F1, the valve is opened. On the other hand, in case F1 is greater than F2, the valve is closed. In this embodiment, W1 and W2 are experimentally obtained, and S1 is determined based upon the W1 thus obtained. The diameter D of the middle portion of the diaphragm 175 is then determined using the above-described relation such that the valve body 176 can be opened and closed at a predetermined operating pressure (e.g., 1200 Pa) which is lower than atmospheric pressure, by making substantially the atmospheric pressure to serve as a reference adjustment pressure. The outer diameter of the diaphragm main body 252 and the outer diameter of the pressure-receiving plate 253 are then determined.

In a state in which the diaphragm 175 is deformed in the positive direction, when the function liquid is consumed (ejected) through the function liquid droplet ejection head 41 so that the pressure in the secondary chamber increases in negative pressure, the diaphragm 175 is pushed by the atmospheric pressure from the neutral state to the negatively deformed state (i.e., the state of deforming in the right direction as seen in FIG. 8A). The diaphragm 175 thus deformed presses the valve body 176 through the pressure-receiving plate 253, thereby slowly opening the valve. Once the valve body 176 opens, the function liquid flows from the primary chamber 172 into the secondary chamber 173 through the communication flow passage 174. This results in an increase in the pressure in the secondary chamber 173, thereby slowly closing the valve body 176. After closing of the valve body 176, the spring force is applied to the diaphragm 175 from the receiving-plate pressing spring 268, leading to the deformation of the diaphragm 175 in the positive direction and also leading to a slightly negative pressure in the secondary chamber 173. By slowly repeating the above-described operation cycle, the function liquid is supplied while maintaining the secondary chamber 173 at a substantially constant pressure.

In the same manner, at the time of initial filling (or loading) of the function liquid droplet ejection head with the function liquid, the above-described operation is performed by forced (or active) suction from the side of the function liquid droplet ejection head, thereby filling the flow passage within the valve with the function liquid. The pressure of the function liquid within the secondary chamber 173 is kept lower than the atmospheric pressure by action of the receiving-plate pressing spring 268. Therefore, by keeping constant the difference in height between the position of the function liquid droplet head 41 (nozzle face 57) and the position of the pressure adjustment valve 161 (center of the diaphragm 175), the dripping (or leaking) of the function liquid from the function liquid droplet ejection head 41 can be prevented.

As described above, the pressure adjustment valve 161 according to this embodiment has a configuration in which open/close operation of the valve body is performed with the atmospheric pressure serving as the reference adjustment pressure. Therefore, the function liquid droplet can be supplied to the function liquid droplet ejection head 41 at a predetermined constant low pressure as long as the pressure in the primary chamber does not become extremely high. Namely, the function liquid droplet ejection head 41 can be stably supplied with the function liquid without being influenced by the water head in the function liquid tank 91.

Each valve supporting member 162 supports the pressure adjustment valve 161 in the vertically disposed state, and is made up of a fixing portion 281 which is fixed with screws to the valve plate 163, and a vertical supporting portion 282 extending from the fixing portion 281 in the vertical direction for mounting and fixing the pressure adjustment valve 161 with screws. As described above, the primary chamber 172, the secondary chamber 173, and the communication flow passage 174 of the pressure adjustment valve 161 are formed concentrically with the diaphragm 175. Therefore, by vertically disposing the pressure adjustment valve 161, air bubbles hardly remain on the inner wall thereof. Furthermore, by vertically disposing the pressure adjustment valve 161, even if air bubbles are contained in the function liquid supplied from the inlet port 201, the bubbles are trapped at the upper portion of the primary chamber 172 or the secondary chamber 173, thereby preventing outflow of the bubbles from the outflow port 241.

As shown in FIGS. 6, 7A, and 7B, the vertical supporting portion 282 includes indicating marks 283 on both faces thereof corresponding to the above-described center position of the diaphragm 175 serving as a reference mark, which allow the user to easily fix the pressure adjustment valve 161 to a predetermined height. Namely, the user mounts and fixes the pressure adjustment valve 161 with the indicating mark 283 matching the above-described mark 271 of the mounting plate 181, thereby enabling to support the pressure adjustment valve 161 at a predetermined height with high precision, and thereby enabling supply of the function liquid from the pressure adjustment valve 161 at a predetermined pressure. In the drawings, reference numeral 284 denotes a slot which allows the user to make positioning or alignment of the mounting plate 181.

As shown in FIG. 10, the difference in the water head between the function liquid droplet ejection head 41 and the pressure adjustment valve 161 is set or determined in advance, and the layout of the function liquid droplet ejection head 41 and the pressure adjustment valve 161 is designed based upon the difference in this set water head. Specifically, the center position of the diaphragm 175 is determined such that the center position of the diaphragm 175 is determined to be higher than the nozzle face 57 of the function liquid droplet ejection head 41 by a predetermined height (95 mm in this embodiment) based upon the set difference in the water head. The height of the center position of the diaphragm 175 relative to the nozzle face 57 of the function liquid droplet ejection head 41 shall preferably be varied with the characteristics (e.g., specific weight) of the function liquid.

Furthermore, in this embodiment, the height of the function liquid tank 91 is determined based upon the position of height of the pressure adjustment valve 161, i.e., the layout thereof is made such that the function liquid flows from the function liquid tank 91 to the pressure adjustment valve 161 due to difference in the water head between the primary chamber of the pressure adjustment valve 161 and the function liquid tank 91 (due to natural downward flow of the function liquid). More specifically, the function liquid tank 91 and the pressure adjustment valve 161 are mounted on the supporting frame 43 such that the supply port 103 of the function liquid tank 91 is positioned at a higher position than the inlet port 211 of the pressure adjustment valve 161. Namely, the height of the function liquid tank 91 is determined based upon the height of the pressure adjustment valve 161 which has been determined based upon the height of the nozzle face 57 of the function liquid droplet ejection head 41 (see FIG. 10).

The valve plate 163 is formed by cutting a rectangular stainless plate of a predetermined thickness, or the like. The valve plate 163 includes the twelve valve supporting members 162 vertically disposed thereon. The twelve valve supporting members 162 are disposed corresponding to the layout of the function liquid droplet ejection heads 41. Namely, the twelve valve supporting members 162 support the twelve pressure adjustment valves 161 so as to be arrayed along the short-side direction of the supporting frame 43 with predetermined offset along the long-side direction thereof between the adjacent pairs of the pressure adjustment valves 161 (see FIG. 3).

The head maintenance apparatus 5 is mounted on the apparatus base 2, and is made up of: a moving table 291 extending in the X-axis direction; a suction unit 292 mounted on the moving table 291; and a wiping unit 293 disposed on the moving table 291 together with the suction unit 292. The moving table 291 is arranged to be movable in the X-axis direction. At the time of maintenance of the function liquid droplet ejection head 41, the moving table 291 is moved to adequately move the suction unit 292 and the wiping unit 293 to the maintenance area 33. The head maintenance apparatus 5 preferably includes an ejection inspecting unit for inspecting ejection of the function liquid from the function liquid droplet ejection head 41, a weighing unit for weighing a droplet of the function liquid ejected from the function liquid droplet ejection head 41, and so forth, in addition to the above-described units.

As shown in FIG. 1, the suction unit 292 is made up of a cap stand 301; a plurality of caps 302 (twelve corresponding to the position of the function liquid droplet ejection head 41) which are supported by the cap stand 301 and which are brought into close contact with the nozzle face of the function liquid droplet ejection head 41; a single suction pump 303 for sucking the (twelve) function liquid droplet ejection heads 41 through the corresponding cap 302; and suction tubes (not illustrated) for connecting the caps 302 to the suction pump 303. Furthermore, the cap stand 301 includes a built-in cap-elevating mechanism 305 (not illustrated) driven by a motor for adjusting the height of each cap 302, thereby enabling control of connection between each function liquid droplet ejection head 41 and the corresponding cap 302. Furthermore, though not illustrated, there are disposed, on the downstream side of the cap 302 of the suction tube (i.e., on the side of the suction pump 303), suction-pressure detecting sensors 306 for detecting the suction pressure and liquid detecting sensors 307 for detecting presence or absence of the function liquid passing through the suction tubes.

With such a configuration, at the time of suction of the function liquid droplet ejection heads 41, the cap-elevating mechanism 305 is driven so as to press each cap 302 into close contact with the nozzle face 57 of the corresponding function liquid droplet ejection head 41 while driving the suction pump 303. This operation causes the suction force to be applied to the function liquid droplet ejection heads 41 through the caps 302, whereby the function liquid droplet ejection heads 41 forcibly eject the function liquid due to the suction force. The above-described suction of the function liquid is performed for solving and preventing the problem of clogging of the function liquid droplet ejection head 41. Furthermore, the suction thereof is performed in order to fill the function liquid flow passages with the function liquid at the time of installing an imaging apparatus 1, at the time of replacement of the function liquid droplet ejection heads 41, or the like.

Each cap 302 has a function to serve as a flushing box for receiving the function liquid ejected from the function liquid droplet ejection head 41 at the time of blank ejection (preliminary ejection). Specifically, periodical flushing is performed before restart of imaging on the work W after temporary pause of imaging at the time of replacement of the work W, or the like. At the time of blank ejection (flushing operation), the cap-elevating mechanism 305 adjusts the position of the cap 302 with a slight gap between the upper face of the cap 302 and the nozzle face 57 of the function liquid droplet ejection head 41.

Furthermore, the suction unit 292 is used for storing the function liquid droplet ejection heads 41 while the imaging apparatus 1 is not operating. In this case, the head unit 15 is moved to the maintenance area 33, and each cap 302 is pressed into contact with the nozzle face 57 of the corresponding function liquid droplet ejection head 41. This operation seals each nozzle face 57 with the corresponding cap 302, thereby preventing the function liquid droplet ejection heads 41 (ejection nozzles 58) from drying, and thereby preventing clogging of the ejection nozzles 58.

As shown in FIG. 1, the wiping unit 293 includes a take-up unit 311 driven by a take-up motor 312 (not illustrated) having a function for winding up a wiping sheet 313 into a wiping-sheet roll while paying out the wiping sheet 313 from another wiping-sheet roll, a washing-liquid supply unit 314 including a washing-liquid nozzle (spraying nozzle: not illustrated) for spraying the washing liquid on the extended wiping sheet 313, and a nozzle-face wiping unit 315 for wiping the nozzle faces 57 with the wiping sheet 313 sprayed with the washing liquid. With a such configuration, the wiping unit 293 is moved to the head unit 15 positioned at the maintenance area 33, and the nozzle faces 57 of the function liquid droplet ejection heads 41 are wiped with the wiping sheet 313 containing the washing liquid, thereby removing stains (of the function liquid) on the nozzle faces 57.

The control apparatus 6 comprises a personal computer, or the like. Furthermore, the control apparatus 6 is connected to input devices (not illustrated) such as a keyboard, a mouse, and so forth, various kinds of drives such as a FD drive, a CD-ROM drive, and so forth, and peripheral devices such as a monitor and so forth.

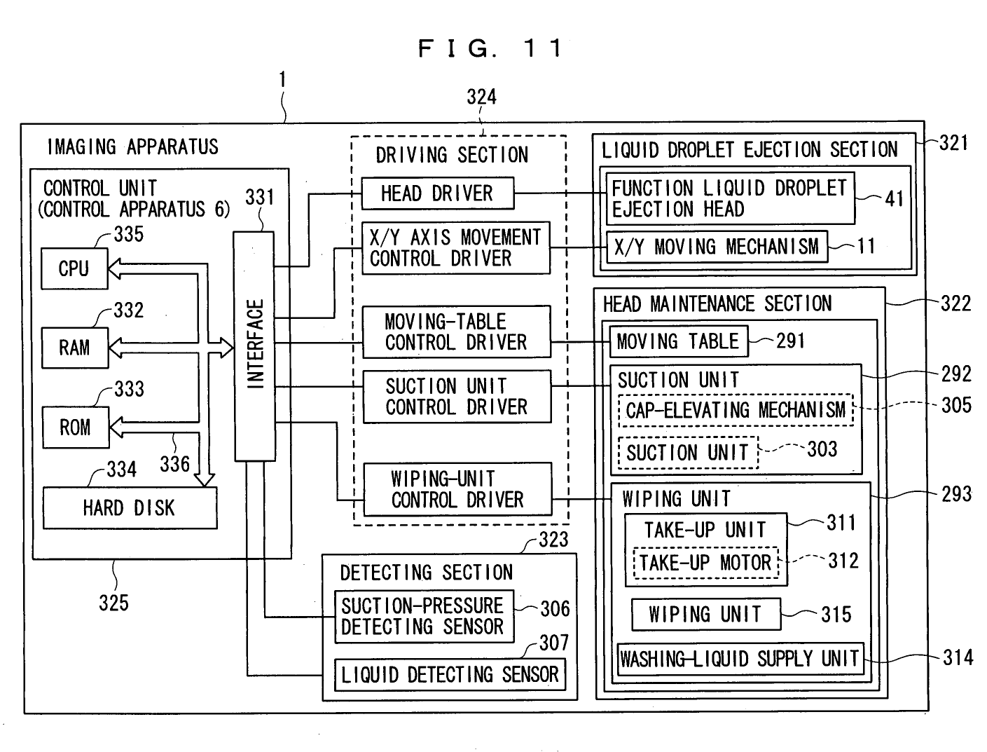

Next, description will be made about a main control system of the imaging apparatus 1 with reference to FIG. 11. The imaging apparatus 1 comprises: a liquid droplet ejection section 321 including the liquid droplet ejection apparatus 3; a head maintenance section 322 including the head maintenance apparatus 5; a detecting section 323 including various kinds of sensors for detecting the state of the liquid droplet ejection apparatus 3 and the state of the head maintenance apparatus 5; a driving section 324 for driving each component; a control unit 325 (control apparatus 6) connected to each component, for controlling each component of the imaging apparatus 1.

The control unit 325 includes: an interface 331 for connecting the liquid droplet ejection apparatus 3 and the head maintenance apparatus 5; RAM 332 serving as a temporary memory region used as a working space for control processing; ROM 333 having various storage regions for storing a control program, control data, and so forth; a hard disk 334 for storing imaging data for making imaging on the work W, and various kinds of data and so forth transmitted from the liquid droplet ejection apparatus 3 and the head maintenance apparatus 5, as well as storing programs and so forth for performing processing for various kinds of data; a CPU 335 for performing computation processing for various kinds of data according to programs and so forth stored in the ROM 333 or the hard disk 334; and a bus 336 for connecting the above-described components.

The control unit 325 having such a configuration receives various kinds of data sets from the liquid droplet ejection apparatus 3, the head maintenance apparatus 5, or the like, through the interface 331, instructs the CPU 335 to perform computation processing according to a program stored in the hard disk 334 (or a program sequentially read out from the CD-ROM drive), and outputs the processing results to the liquid droplet ejection apparatus 3, the head maintenance apparatus 5, or the like, through the interface 331, whereby the control unit 325 controls each component.

On the other hand, the function liquid flow passage formed with a large length from the function liquid tank 91 to the function liquid droplet ejection head 41 leads to the increased useless function liquid remaining in the function liquid flow passage, resulting in a problem of high costs for imaging. Furthermore, such a long function liquid flow passage leads to an increased period of time for transporting the function liquid, often resulting in a problem in that the imaging results are adversely affected by increased loss of the pressure for transporting the function liquid within the flow passage, as well as increased amount of air (dissolved air) contained in the function liquid during transport thereof through the pressure adjustment valve 161 and the function liquid supply tube 72.

Accordingly, as described above, the imaging apparatus 1 according to this embodiment is made up of a unit having the plurality of function liquid droplet ejection heads 41, a unit having the plurality of pressure adjustment valves 161, and a unit having the plurality of function liquid tanks 91, and these units are mounted on the single supporting frame 43. In this manner, it is made possible to minimize the length of the function liquid flow passages. Furthermore, the plurality of function liquid droplet ejection heads 41, the plurality of pressure adjustment valves 161, and the plurality of function liquid tanks 91 are classed into a plurality of groups. In this embodiment, these components are grouped into a plurality of units U. In order to minimize the length of each function liquid flow passage to connect each of the constituting elements within the same unit, the function liquid droplet ejection head 41, the pressure adjustment valve 161, and the function liquid tank 91 are disposed in a straight line in the order mentioned.

Description will be made with reference to FIG. 3. As described above, the pressure adjustment valves 161 and the function liquid tanks 91 are disposed corresponding to the layout of the function liquid droplet ejection heads 41. The imaging apparatus 1 according to this embodiment includes the twelve units U each of which consist of the single function liquid droplet ejection head 41, the corresponding single pressure adjustment valve 161, and the corresponding single function liquid tank 91. In this embodiment, the head unit 15, the valve unit 74, and the tank unit 71 are mounted on the supporting frame 43 such that the twelve units U are disposed along the short-side direction of the supporting frame 43 with a predetermined offset in the long-side direction between adjacent pairs of the units U. With such a configuration, the function liquid droplet ejection head 41, the pressure adjustment valve 161, and the function liquid tank 91, in each unit U are disposed generally straight along the long-side direction of the supporting frame 43. Such a configuration in which the components in each unit U are disposed generally straight has the advantage of enabling formation of the imaging apparatus 1 with a short function liquid flow passage in each unit U, as compared with a configuration in which the components in each unit are not disposed in a straight line. Furthermore, with such a configuration, the function liquid flow passage between the components in each unit U are formed with the same length, thereby enabling supply of the function liquid through each function liquid path with the same pressure loss and the same amount of dissolved air, and thereby preventing irregularities in imaging made by the function liquid droplet ejection heads 41.

Furthermore, each function liquid droplet ejection head 41 is preferably disposed with the function liquid introduction portion 51 facing the direction of the pressure adjustment valve 161 (upstream direction), thereby preventing stains of the function liquid on the head base 53 of the function liquid droplet ejection head 41 at the time of replacement of the function liquid supply tube 72 forming the function liquid flow passage, or the like.

In this embodiment, the number of the function liquid droplet ejection heads 41, the number of the pressure adjustment valves 161, and the number of the function liquid tanks 91 are not restricted in particular. Accordingly, the number of the units U and the number of the components forming each unit U are suitably set to desired numbers. For example, an arrangement may be made in which each unit U consists of the single function liquid droplet ejection head 41, the two pressure adjustment valves 161 (corresponding to the number of the connecting needles 52 of the function liquid droplet ejection head 41), and the single function liquid tank 91. In this case, the components forming each unit U are preferably disposed generally straight, as well, thereby allowing formation of the short function liquid flow passages. Furthermore, the components forming each unit U are more preferably disposed with the line symmetry, thereby enabling uniform supply of the function liquid from the function liquid droplet ejection heads 41.

Next, description will be made about a configuration of an electro-optical device (flat panel display) manufactured using the imaging apparatus 1 according to this embodiment and a method of manufacturing thereof, with a color filter, a liquid-crystal display device, an organic EL device, plasma display panel (PDP device), an electron emission device (FED device, SED device), an active matrix panel including the above-described devices, and so forth, as examples. The active matrix panel used here means a panel including thin film transistors, and source lines and gate lines electrically connected to the thin film transistors, each of which are formed thereon.

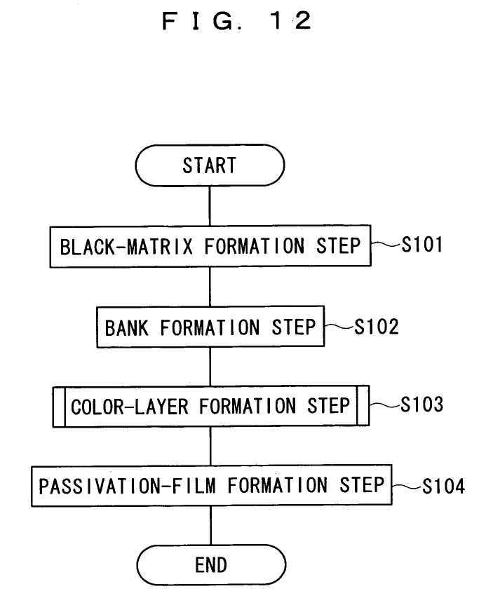

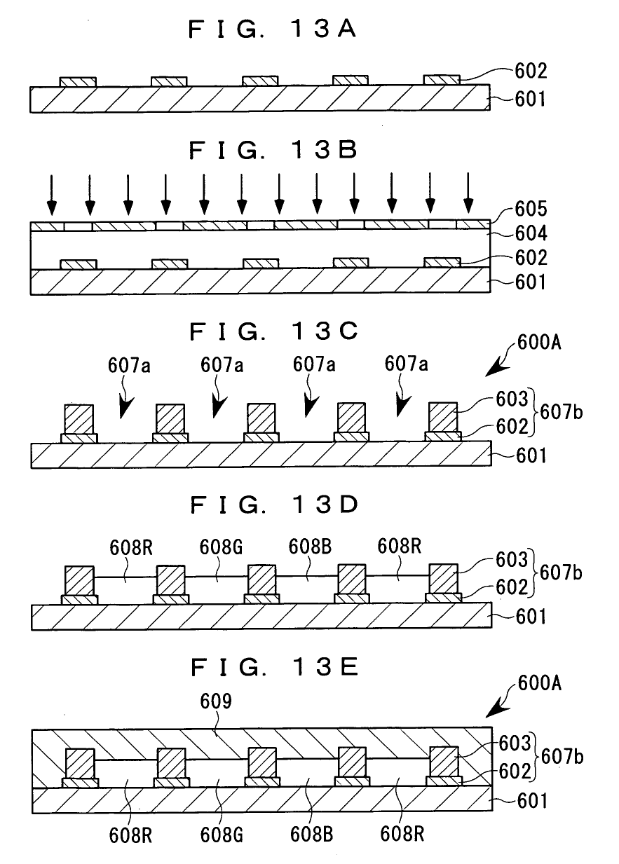

Now, description will be made about a method of manufacturing a color filter employed in a liquid display device, an organic EL device, or the like. FIG. 12 is a flowchart for describing a manufacturing process for the color filter, and FIGS. 13A through 13E are schematic cross-sectional views of a color filter 600 (filter base 600A) in each manufacturing step according to this embodiment.

First, in black-matrix formation step (S10), a black matrix 602 is formed on a substrate (W) 601 as shown in FIG. 13A. The black matrix 602 is formed of metallic chromium, a layered structure of metallic chromium and chromium oxide, resin, or the like. For example, the black matrix 602 is formed of a metallic thin film using a sputtering method, an evaporation method, or the like. On the other hand, the black matrix 602 is formed of a resin thin film using a gravure method, a photo-resist method, a thermal transfer method, or the like.

Subsequently, in a bank formation step (S102), banks 603 are formed so as to be overlaid on the black matrix 602. Namely, first, a photo-resist layer 604 is formed so as to cover the substrate 601 and the black matrix 602 as shown in FIG. 13B. The photo-resist layer 604 is formed of transparent negative photosensitive resin. Then, exposure processing is performed for the photo-resist layer 604 with a mask film 605 covered thereon in the form of a matrix pattern.

As shown in FIG. 13C, etching processing is performed for the black matrix 602 with the remaining photo-resist layer 604 in the form of a matrix pattern, whereby the banks 603 are formed. An arrangement may be made in which the black matrix formed of resin serves as the banks.

Each bank 603 and the component of the black matrix 602 positioned thereunderneath serve as a partition wall 607b for partitioning the black matrix 602 into pixel regions 607a, which determine the landing regions onto which the function liquid droplets are to be ejected in a color-layer formation step described later where color layers (color films) 608R, 608G, and 608B, are formed with the function liquid droplet ejection heads 41.

In this embodiment, the above-described filter base 600A is manufactured according to the manufacturing process from the black matrix formation step through the bank formation step as described above.

In this embodiment, the banks 603 are formed of resin having hydrophobic property. Conversely, the substrate (glass substrate) 601 has a hydrophilic surface, thereby improving the precision of the landing position of the droplet which is ejected onto each pixel region 607a surrounded by the bank 603 (partition wall 607b) in the color-layer formation step described later.

Subsequently, in the color-layer formation step (S103), as shown in FIG. 13D, the function liquid droplet ejection heads 41 eject the function liquid droplets such that the function liquid droplets land on the corresponding pixel regions 607a each of which is surrounded by the partition wall 607b. Three kinds of the function liquids (filter materials) are employed for the colors of R, G, and B. Examples of the pattern arrangements of three colors of R, G, and B include a stripe pattern, a mosaic pattern, a delta pattern, and so forth.

Subsequently, the color filter 600 is subjected to drying processing (heating processing, or the like) so as to fix the function liquids, whereby three kinds of color layers 608R, 608G, and 608B are formed. Following formation of the color layers 608R, 608G, and 608B, the procedure proceeds to the passivation-film formation step (S104), where a passivation film 609 is formed so as to coat the substrate 601, the partition walls 607b, and the color layers 608R, 608G, and 608B, as shown in FIG. 13E.

Namely, following ejection of the passivation coating liquid onto the entire face of the substrate 601 on which the color layers 608R, 608G, and 608B, have been formed, the color filter 600 is subjected to drying processing, whereby the passivation film 609 is formed.

Subsequently, following formation of the passivation film 609, the procedure proceeds to the film-formation step in which transparent electrodes such as indium tin oxide (ITO) electrodes, or the like are formed.

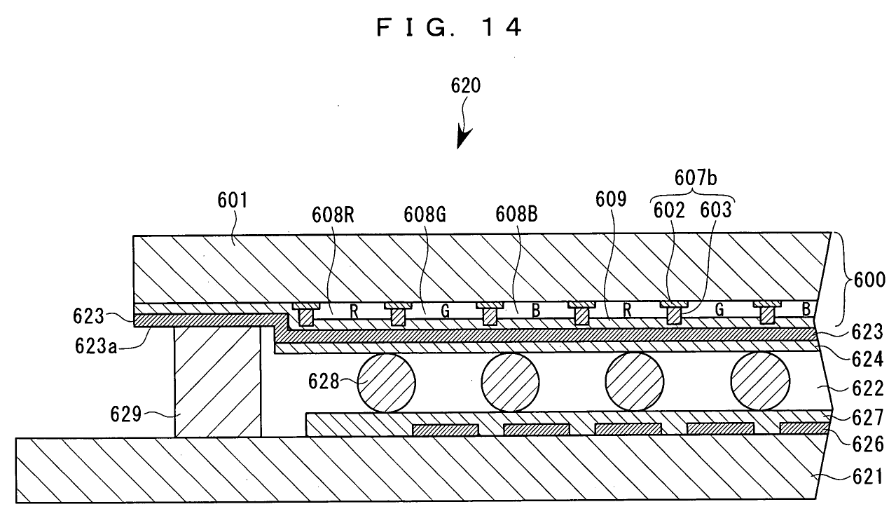

FIG. 14 is a schematic cross-sectional view which shows a schematic configuration of a passive matrix liquid crystal device (liquid crystal device) which is a kind of the liquid crystal display device employing the above-described color filter 600. A transmissive type of liquid crystal display device which is a final product includes the liquid crystal device 620 and accessory components such as liquid-crystal driving ICs, a backlight, supporting members, or the like. The color filter 600 shown in FIG. 14 has the same configuration as in FIGS. 13A-13E and, accordingly, the same components are denoted by the same reference numerals, and description thereof will be omitted.

The liquid crystal device 620 has a schematic configuration in which a liquid-crystal layer 622 formed of super twisted nematic (STN) crystal liquid composition of matter is held between the color filter 600 and an opposite substrate 621 formed of a glass substrate, or the like. The color filter 600 serves as the upper substrate (on the side of the viewer).

The opposite substrate 621 and the color filter 600 include polarizing plates (not illustrated) on the outer faces thereof (opposite face of the liquid crystal layer 622). Furthermore, a backlight (not illustrated) is disposed at a position facing the polarizing plate disposed on the opposite substrate 621.

As shown in FIG. 14, a plurality of stripe-shaped first electrodes 623 are formed on the passivation film 609 (facing the liquid-crystal layer) of the color filter 600 at a predetermined pitch, each of which extend in the horizontal direction. Furthermore, a first alignment film 624 is formed on the face of the passivation film 609 including the first electrode 623 opposite to the color filter 600.

On the other hand, a plurality of stripe-shaped second electrodes 626 are formed on the face of the opposite substrate 621 at a predetermined pitch so as to face the color filter 600, each of which extend in the direction orthogonal to the direction in which each first electrode 623 extends. Furthermore, a second alignment film 627 is formed so as to coat the face including the second electrodes 626 facing the liquid-crystal layer 622. The first electrodes 623 and the second electrodes 626 are formed of a transparent conductive material such as ITO, or the like.

The liquid crystal device 620 includes spacers 628 within the liquid-crystal layer 622 for maintaining the thickness (cell gap) of the liquid-crystal layer 622. Furthermore, seal members 629 are included for preventing leakage of the liquid-crystal composition of matter forming the liquid-crystal layer 622. One end of the first electrodes extends outside the seal members 629, which are used as external electrodes 623a.

With such a configuration, each crossing of the first electrode 623 and the second electrode 626 serves as a pixel. Accordingly, each pixel thus determined includes any one of the color layers 608R, 608G, and 608B, forming the color filter 600.

With the general manufacturing process, the liquid crystal device 620 is manufactured as follows. Namely, first, patterning processing is performed for the first electrode layer on the color filter 600, following which the passivation film 609 including the patterned first electrodes 623 is coated with the first alignment film 624, whereby the color filter 600 is formed. Separately, patterning processing is performed for the second electrode layer on the opposite substrate 621, following which the opposite substrate 621 including the patterned second electrodes 626 is coated with the second alignment film 627, whereby the opposite substrate 621 is formed. Subsequently, the spacers 628 and the seal members 629 are disposed on the opposite substrate 621, following which the color filter 600 is attached to the opposite substrate 621. Subsequently, the liquid crystal is injected from an injection port formed on the seal member 629 for forming the liquid-crystal layer 622, following which the injection port is closed. Subsequently, a pair of polarizing plates and a backlight are mounted on the liquid crystal device 620.

The imaging apparatus 1 according to this embodiment may be used for coating a spacer material (function liquid) forming the above-described cell gap, and for coating the liquid crystal (function liquid) on the region surrounded by the seal members 629 with high uniformity before the attachment processing in which the color filter 600 is attached to the opposite substrate 621, for example. Furthermore, the imaging apparatus 1 according to this embodiment may be used for forming the above-described seal members 629 by imaging with the function liquid droplet ejection heads 41. Furthermore, the imaging apparatus 1 according to this embodiment may be used for coating the first and second alignment films 624 and 627 by imaging with the function liquid droplet ejection heads 41.

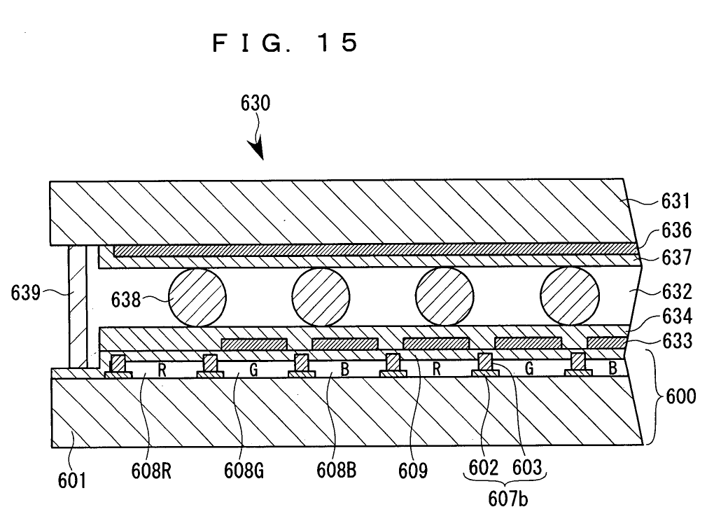

FIG. 15 is a schematic cross-sectional view which shows a schematic configuration of a second example of a liquid-crystal device (i.e., liquid-crystal device 630) employing the color filter 600 according to this embodiment.

The essential difference between the liquid-crystal device 630 and the above-described liquid-crystal device 620 is that the color filter 600 of the liquid-crystal device 630 serves as the lower substrate (opposite side of the viewer).

The liquid crystal device 630 has a schematic configuration in which a liquid-crystal layer 632 formed of the STN crystal liquid is held between the color filter 600 and an opposite substrate 631 formed of a glass substrate, or the like. The opposite substrate 631 and the color filter 600 include polarizing plates (not illustrated) on the outer faces thereof.

Furthermore, a plurality of stripe-shaped first electrodes 633 are formed on the passivation film 609 (facing the liquid-crystal layer 632) on the color filter 600 at a predetermined pitch, each of which extends in the direction orthogonal to the drawing. Furthermore, a first alignment film 634 is formed so as to coat the first electrodes 633 facing the liquid-crystal layer 632.

A plurality of stripe-shaped second electrodes 636 are formed on the opposite substrate 631 facing the color filter 600 at a predetermined pitch, each of which extends in the direction orthogonal to the direction in which the first electrodes 633 extend. Furthermore, a second alignment film 637 is formed so as to coat the second electrodes 636 facing the liquid-crystal layer 632.

The liquid crystal device 630 includes spacers 638 within the liquid-crystal layer 632 for maintaining the thickness of the liquid-crystal layer 632. Furthermore, seal members 639 are included for preventing leakage of the liquid-crystal composition of matter forming the liquid-crystal layer 632.

With such a configuration, each crossing of the first electrode 633 and the second electrode 636 serves as a pixel in the same way as with the above-described liquid-crystal device 620. Accordingly, each pixel thus determined includes any one of the color layers 608R, 608G, and 608B forming the color filter 600.

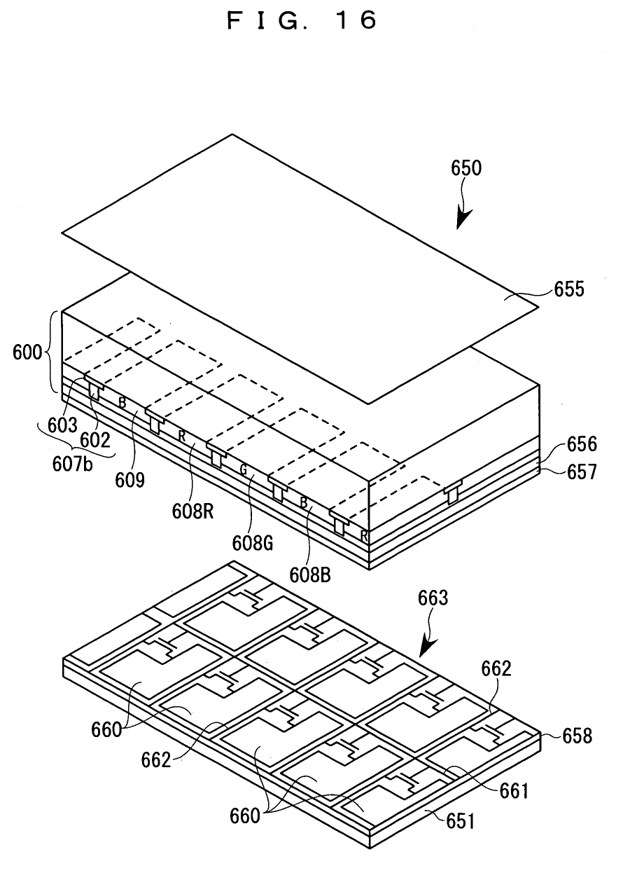

FIG. 16 is an exploded perspective view which shows a schematic configuration of a transmissive type of thin film transistor (TFT) liquid-crystal device (liquid-crystal device 650) which is a third example employing the color filter 600 according to this invention.

With the liquid-crystal device 650, the color filter 600 serves as the upper substrate (on the side of the viewer) in the drawing.

The liquid-crystal device 650 generally comprises the color filter 600, an opposite substrate 651 disposed so as to face the color filter 600, a liquid-crystal layer (not illustrated) between the color filter 600 and the opposite substrate 651, a polarizing plate 655 disposed on the upper face (on the side of the viewer) of the color filter 600, and a polarizing plate (not illustrated) disposed on the lower face of the opposite substrate 651.

Furthermore, an electrode 656 for driving the liquid crystal device is formed on the surface (facing the opposite substrate 651) of the passivation film 609. The electrode 656 is formed of a transparent conductive material such as ITO, or the like, and is formed as a full-face electrode which coats the entire region where pixel electrodes 660 described later are formed. Furthermore, an alignment film 657 is formed on the electrode 656 facing the pixel electrodes 660.

An insulating layer 658 is formed on the face of the opposite substrate 651 facing the color filter 600. Furthermore, scanning lines 661 and signal lines 662 are formed on the insulating layer 658 orthogonal to each other. With such a configuration, the pixel electrode 660 is formed in each region surrounded by the scanning lines 661 and the signal lines 662. Actual liquid-crystal devices include an alignment film (not illustrated) on each pixel electrode 660.

Furthermore, a thin film transistor 663 is formed in the notch portion surrounded by the pixel electrode 660, the scanning line 661, and the signal line 662. Each thin film transistor 663 comprises a source electrode, a drain electrode, a semiconductor layer, and a gate electrode. With such a configuration, each thin film transistor 663 is on/off controlled by signals applied to the scanning lines 661 and the signal lines 662, thereby controlling each pixel electrode 660.

While description has been made about an arrangement having a transmissive type of configuration such as the above-described liquid-crystal devices 620, 630, and 650, this invention may be applied to a reflection liquid-crystal device including a reflecting layer or a semi-transmissive type of liquid-crystal device including a semi-transmissive layer.

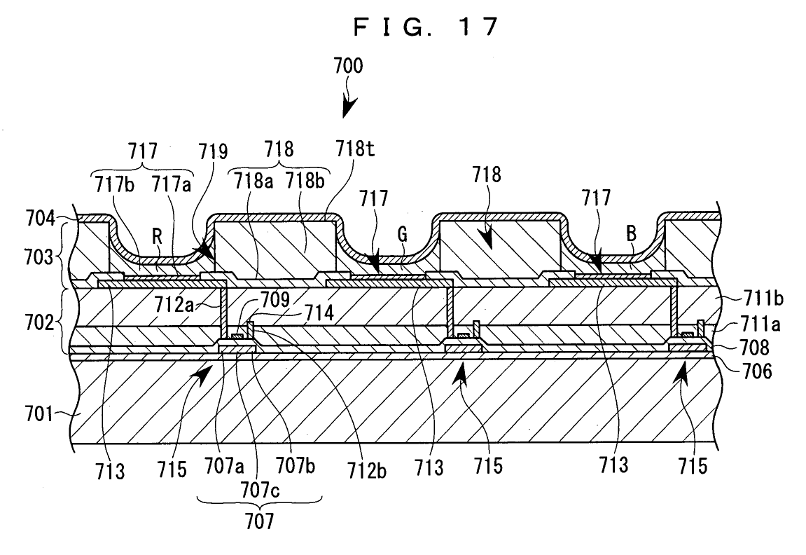

FIG. 17 is a schematic cross-sectional view which shows a display region of an organic EL device (which will be simply referred to as “display device 700” hereinafter).

The display device 700 has a schematic configuration in which a circuit device portion 702, an emission device portion 703, and a cathode 704, are layered on a substrate (W) 701.

With the display device 700, the light emitted from the emission device portion 703 toward the opposite side of the substrate 701 is reflected by the cathode 704, following which the reflected light passes through the circuit device portion 702 and the substrate 701, whereby the reflected light is cast toward the viewer, as well as the light emitted from the emitting device portion 703 toward the substrate 701 passing through the circuit device portion 702 and the substrate 701 without reflection.

Furthermore, a substrate passivation film 706 is formed of silicon oxide between the circuit device portion 702 and the substrate 701. Furthermore, semiconductor films 707 are formed of polysilicon on the substrate passivation film 706 (facing the emission device portion 703) in the form of spots. Each semiconductor film 707 includes a source region 707a and a drain region 707b in the left and the right regions thereof formed by high-concentration positive-ion implantation. On the other hand, the middle portion which has not been subjected to positive-ion implantation serves as a channel region 707c.

Furthermore, the circuit device portion 702 includes a transparent gate insulating film 708 which coats the substrate passivation film 706 and the semiconductor films 707. A gate electrode 709 is formed of Al, Mo, Ta, Ti, W, or the like, at a position on the gate insulating film 708 corresponding to the channel region 707c of each semiconductor film 707. Furthermore, a transparent first interlayer insulating film 711a and a transparent second interlayer insulating film 711b are formed on the gate electrodes 709 and the gate insulating film 708. Contact holes 712a and 712b which are through holes formed in the first and second interlayer insulating films 711a and 711b communicate with the source region 707a and the drain region 707b of each semiconductor film 707.

Transparent pixel electrodes 713 are formed of ITO, or the like on the second interlayer insulating film 711b in a predetermined shape by patterning processing. Each pixel electrode 713 is connected to the source region 707a through the contact hole 712b.

Power-supply lines 714 are formed on the first interlayer insulating film 711a, and the power-supply line 714 is connected to the drain region 707b through the contact hole 712b.

As described above, the thin film transistors 715 are formed in the circuit device portion 702, each of which are connected to the corresponding pixel electrode 713 for driving the pixel.

The above-described emitting device portion 703 generally comprises functional layers 717 each of which is layered on one of the plurality of pixel electrodes 713, and the bank portions 718 each of which is formed between the pixel electrode 713 and the functional layer 717, serving as a partition between the adjacent functional layers 717.

Each emission device is formed of the pixel electrode 713, the functional layer 717, and the cathode 704 on the functional layer 717. The pixel electrode 713 is formed generally in the shape of a rectangle by patterning processing. Furthermore, the bank portion 718 is formed between the adjacent pixel electrodes 713.

The bank portion 718 is formed of an inorganic bank layer 718a (first bank layer) formed of an inorganic material such as SiO, SiO₂, TiO₂, or the like, and an organic bank layer 718b (second bank layer) formed of resist having high heat-resisting properties and high solvent-resisting properties such as acrylic resin, polyimide resin, or the like, which has a trapezoidal cross-section, on the inorganic bank layer 718a. A part of the bank portion 718 is formed on the edge of the pixel electrode 713.

An opening 719 is formed between the adjacent bank portions 718, corresponding to the pixel electrode 713. Each opening 719 expands in the upward direction.

The above-described functional layer 717 is formed of a hole injection/transporting layer 717a having a layered structure formed on the pixel electrode 713 within the opening 719, and the emitting layer 717b formed on the hole injection/transporting layer 717a. Another kind of functional layer having different functions may be formed adjacent to the emitting layer 717b. For example, an arrangement may be made in which an electron-transfer layer is formed adjacent to the hole injection/transporting layer 717a.

The hole injection/transporting layer 717a has functions for transporting holes from the pixel electrode 713, and injecting the holes into the emitting layer 717b. With the imaging apparatus according to this invention, the first composition of matter (function liquid) containing a hole injection/transporting layer formation material is ejected, whereby the hole injection/transporting layer 717a is formed. A known material may be employed as the hole injection/transporting layer formation material.

The emitting layer 717b has a function for emitting light in any color of red (R), green (G), and blue (B). With the imaging apparatus according to this invention, second composition of matter (function liquid) containing an emitting layer formation material (emitting material) is ejected, whereby the emitting layer 717b is formed. While a known solvent (non-polar solvent) may be employed for the second composition of matter, the hole injection/transporting layer 717a preferably has sufficient solvent-resistance against the above-described solvent thus employed for the second composition of matter for forming the emitting layer 717b, thereby enabling formation of the emitting layer 717b without deterioration in the hole injection/transporting layer 717a.

The emitting layer 717b thus formed has a configuration in which holes injected from the hole injection/transporting layer 717a and electrons injected from the cathode 704 recombine with each other, thereby emitting light.

The cathode 704 is formed so as to coat the entire face of the emitting device portion 703, and the cathode 704 and the pixel electrode 713 form a pair of electrodes, whereby current flows in the functional layer 717 therebetween. A seal member (not illustrated) is formed on the upper face of the cathode 704.

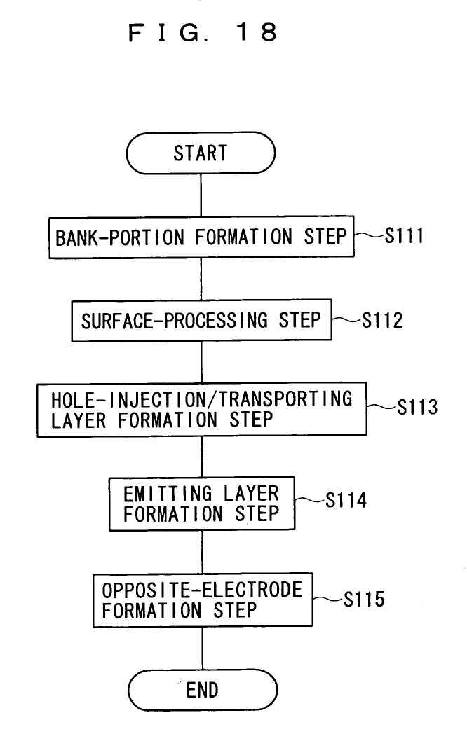

Next, description will be made about a manufacturing process for the above-described display device 700 with reference to FIGS. 18 through 26.

As shown in FIG. 18, the display device 700 is manufactured according to the manufacturing process including: a bank-portion formation step (Sill); a surface processing step (S112); a hole injection/transporting layer formation step (S113); an emitting layer formation step (S114); and an opposite electrode formation step (S115). The manufacturing process according to this invention is not restricted to the above-described one; rather, some of the steps may be omitted, or another step or other steps may be added, as required.

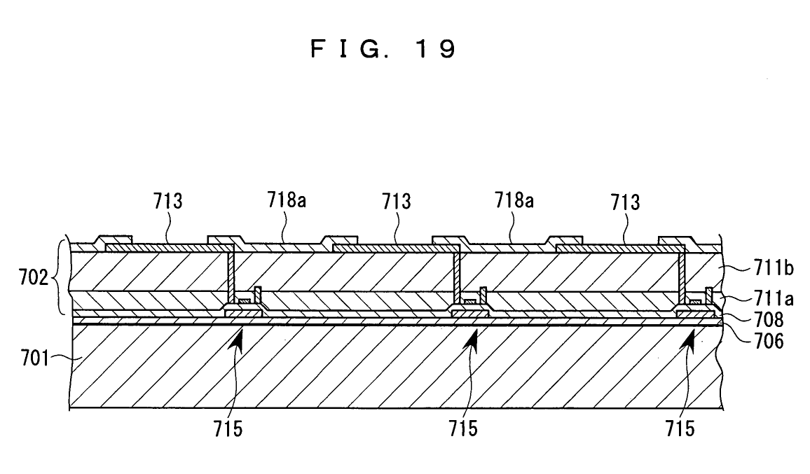

First, as shown in FIG. 19, in the bank-portion formation step (S111), the inorganic bank layer 718a is formed on the second interlayer insulating film 711b. Specifically, an inorganic film is formed at a predetermined portion, following which the inorganic film is subjected to patterning processing using the photolithographic technique, or the like, whereby the inorganic bank layer 718a is formed. The inorganic bank layer 718a is formed such that a part thereof is formed on the edge of the pixel electrode 713.

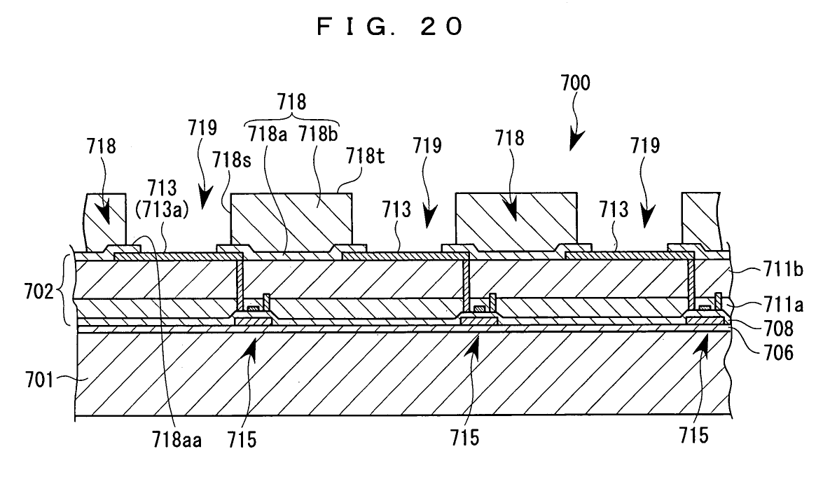

Following formation of the inorganic bank layer 718a, the organic bank layer 718b is formed on the inorganic bank layer 718a as shown in FIG. 20. The organic bank layer 718b is formed by patterning processing using the photolithographic technology in the same way as with the inorganic bank layer 718a.

As described above, the bank portions 718 are formed. At the same time, the opening 719 is formed between the adjacent bank portions 718 so as to face upward. Each opening 719 determines or defines a pixel region.

In the surface processing step (S112), lyophilic-surface formation processing and lyophobic-surface formation processing are performed. The lyophilic-surface formation processing is performed for the first layered portion 718aa of the inorganic bank layer 718a and the electrode face 713a of the pixel electrode 713. Specifically, the surfaces of these regions are subjected to plasma processing using a processing gas such as oxygen, or the like, thereby forming lyophilic surfaces thereon. The plasma processing has also a function for washing ITO which serves as the pixel electrodes 713.

On the other hand, the lyophobic-surface formation processing is performed for the wall face 718s of the organic bank layer 718b and the upper face 718t of the organic bank layer 718b. Specifically, the surfaces of these regions are subjected to plasma processing using a processing gas such as tetra-fluoro-methane, or the like, thereby forming fluoride surfaces (lyophobic surfaces) thereon.

The surface processing step enables high-precision formation of the functional layer 717 with the function liquid droplet ejection heads 41 in a sure manner. Namely, the surface processing enables the function liquid droplets to land on the target pixel region in a surer manner while preventing leakage of the function liquid droplets which have landed on the pixel region, from the openings 719.

As described above, the display device base 700A is manufactured according to the above-described steps. Then, the display device base 700A thus manufactured is mounted on the set table 23 of the imaging apparatus 1 shown in FIG. 1 for performing the hole injection/transporting layer formation step (S113) and the emitting layer formation step (S114) described below.

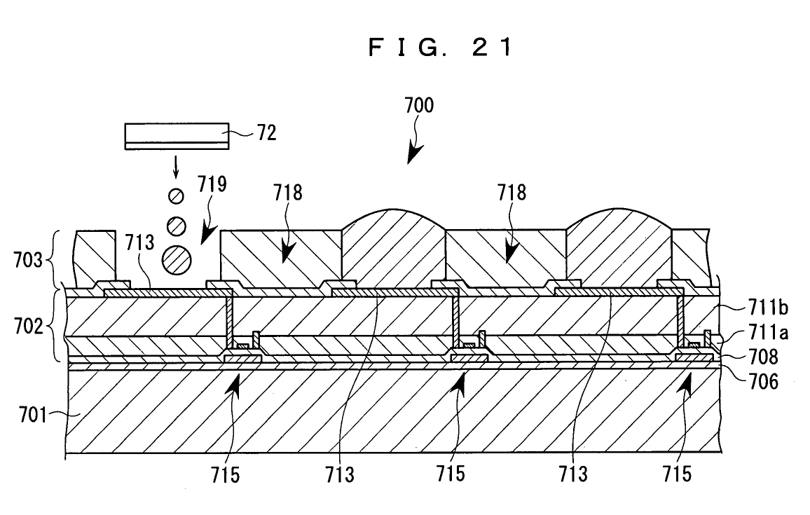

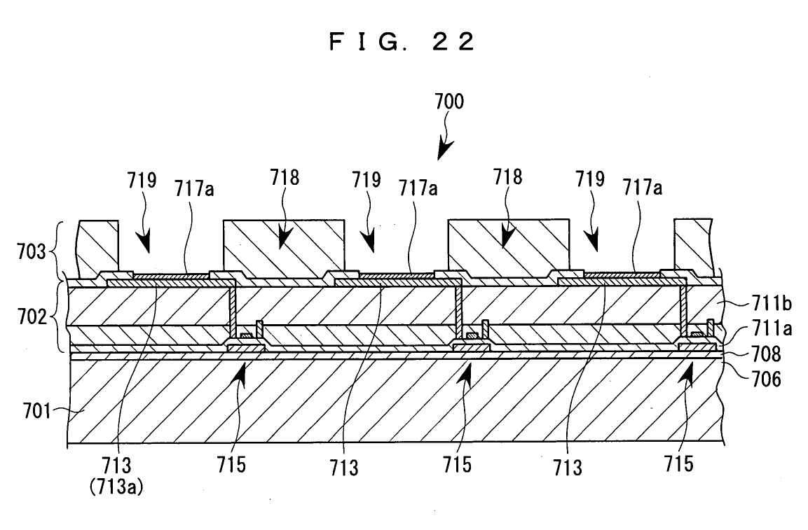

As shown in FIG. 21, in the hole injection/transporting layer formation step (S113), the function liquid droplet ejection head 41 ejects the first composition of matter containing a hole injection/transporting layer formation material onto each opening 719 serving as a pixel region. Subsequently, as shown in FIG. 22, drying processing and heat processing are performed for evaporating the polar solvent contained in the first composition of matter, thereby forming the hole injection/transporting layer 717a on each electrode pixel 713 (electrode face 713a thereof).

Next, description will be made about the emitting layer formation step (S114). In the emitting layer formation step, a non-polar solvent which does not causes damage to the hole injection/transporting layer 717a is employed as the solvent for the second composition of matter for forming the emitting layer, thereby enabling formation of the emitting layer 717b while preventing deterioration in the hole injection/transporting layer 717a.

However, the hole injection/transporting layer 717a has low affinity to the non-polar solvent, often leading to a problem in that the emitting layer 717b is not formed with sufficient adhesion to the hole injection/transporting layer 717a, or a problem in that the emitting layer 717b is not coated with sufficient uniformity, in the step for forming the emitting layer 717b where the second composition of matter containing the non-polar solvent is ejected onto the hole injection/transporting layer 717a.

Accordingly, surface processing (surface improvement processing) is preferably performed before formation of the emitting layer for improving affinity of the surface of the hole injection/transporting layer 717a to the non-polar solvent and the emitting layer formation material. Specifically, the same solvent as the non-polar solvent for the second composition of matter for forming the emitting layer, or a surface improvement material which is a solvent similar to the above-described non-polar solvent, is coated on the hole injection/transporting layer 717a, following which drying processing is performed, whereby the surface processing is performed.

Such surface processing improves affinity of the surface of the hole injection/transporting layer 717a to the non-polar solvent, thereby allowing the following step to coat the hole injection/transporting layer 717a with the second composition of matter containing the emitting formation material with sufficient uniformity.

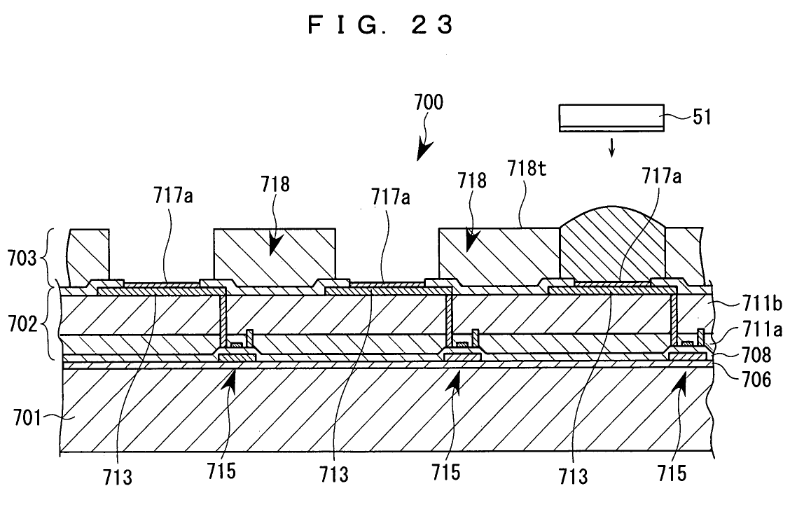

Next, as shown in FIG. 23, a predetermined amount of the function liquid droplets, i.e., the second composition of matter containing the emitting layer formation material corresponding to any color of red, green, and blue, is ejected onto each pixel region (the opening 719 thereof). Note that FIG. 23 shows the pixel region onto which the second composition of matter corresponding to blue (B) has been ejected. The second composition of matter which has landed on the pixel region spreads over the hole injection/transporting layer 717a, and the opening 719 is filled therewith. Even if the second composition of matter has landed on the unintended upper face 718t of the bank portion 718, the second composition of matter readily migrates to the opening 719 due to the upper face 718t subjected to the lyophobic-surface formation processing as described above.

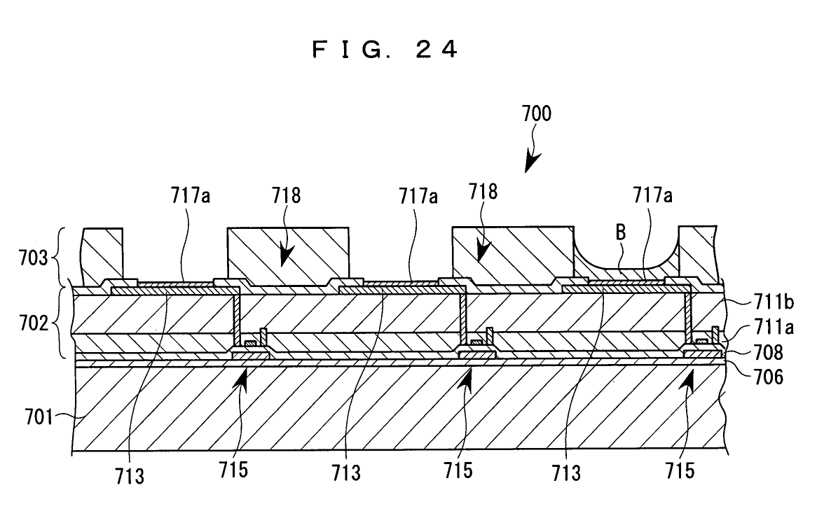

Subsequently, drying processing, or the like is performed for drying the second composition of matter thus ejected, thereby evaporating the non-polar solvent contained in the second composition of matter, and thereby forming the emitting layer 717b on the hole injection/transporting layer 717a as shown in FIG. 24. FIG. 24 shows an example in which the emitting layer 717b corresponding to blue (B) is formed as described above.

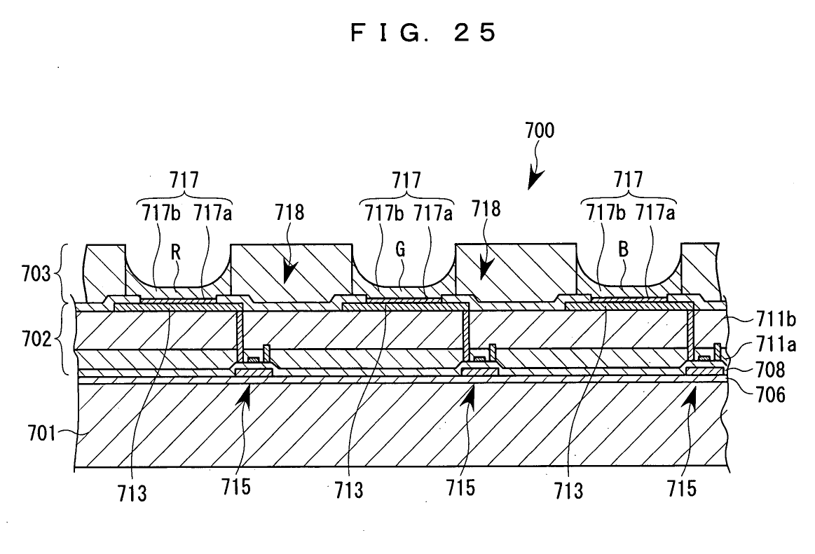

Furthermore, as shown in FIG. 25, formation of the emitting layer 717b is made for the other colors (red (R) and green (G)) using the other function liquid droplet ejection heads in the same way as with the emitting layer 717b corresponding to blue (B) described above. The order of formation of the emitting layers 717b is not restricted in particular; rather the emitting layers 717b may be formed in a desired order. For example, the order of formation of the emitting layers 717b may be determined based upon the kinds of the emitting layer formation materials. On the other hand, examples of the pattern arrangements of three colors of R, G, and B, include a stripe pattern, a mosaic pattern, a delta pattern, and so forth.

Thus, the functional layer 717, i.e., the hole injection/transporting layer 717a and the emitting layers 717b are formed on each pixel electrode 713. Then, the procedure proceeds to the opposite electrode formation step (S25).

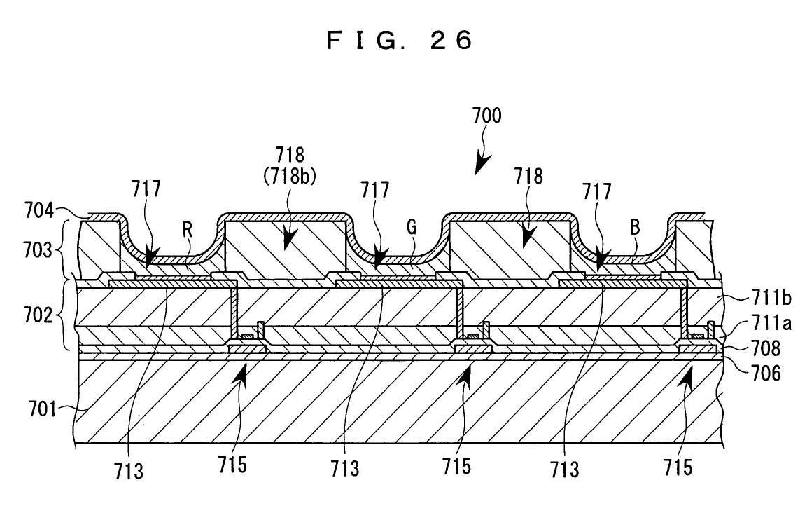

In the opposite electrode formation step (S25), as shown FIG. 26, the cathode 704 (opposite electrode) is formed on the entire face of the emitting layers 717b and the organic bank layers 718b in the evaporation method, the sputtering method, the CVD method, or the like. The cathode 704 according to this embodiment has a layered structure in which a calcium layer and an aluminum layer are layered, for example.

Furthermore, an Al film or Ag film serving as an electrode, and a passivation film for preventing oxidization of the electrode, such as an SiO₂ film, an SiN film, or the like, are formed on the upper face of the cathode 704, as required.

Following formation of the cathode 704 as described above, other processing is performed, whereby the display device 700 is manufactured. Examples of the above-described other processing include sealing processing in which the upper face of the cathode 704 is sealed with a seal member, wiring processing, and so forth.

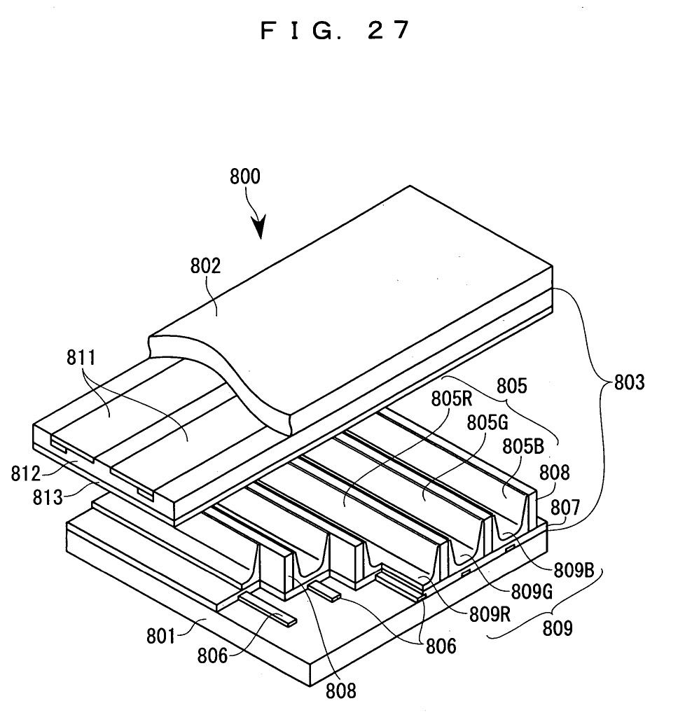

FIG. 27 is an exploded perspective view of a plasma display panel device (PDP device, which will be simply referred to as “display device 800” hereinafter). In this figure the display device 800 is partly shown in a cut-away style.

The display device 800 generally comprises a first substrate 801 and a second substrate 802 facing one another, and a discharge display portion 803 formed therebetween. The discharge display portion 803 is formed of a plurality of discharge chambers 805. The plurality of discharge chambers 805 are made up of red discharge chambers 805R, green discharge chambers 805G, and blue discharge chambers 805B. The layout of the discharge chambers 803 is designed such that each pixel is formed of a combination of the red discharge chamber 805R, the green discharge chamber 805G, and the blue discharge chambers 805B.

Furthermore, stripe-shaped address electrodes 806 are formed on the first substrate 801 at a predetermined pitch. A dielectric layer 807 is formed so as to coat the address electrodes 806 and the upper face of the first substrate 801. In addition, partition walls 808 are erected between the adjacent address electrodes 806 so as to extend therealong. While FIG. 27 shows the partition walls 808 erected between the adjacent address electrodes 806 so as to extend therealong, the first substrate 801 includes partition walls 808, though not illustrated, extending orthogonal to the address electrodes 806.

With such a configuration, each region surrounded by the above-described partition walls 808 serves as the discharge chamber 805. Each discharge chamber 805 includes a fluorescent member 809 therewithin. The fluorescent member 809 has a function for emitting light in any color of red (R), green (G), and blue (B). Specifically, the red discharge chamber 805R includes red fluorescent member 809R on the bottom thereof, the green discharge chamber 805G includes green fluorescent member 809G on the bottom thereof, and the blue discharge chamber 805B includes blue fluorescent member 809B on the bottom thereof.

On the other hand, as shown in the drawing, a plurality of stripe-shaped display electrodes 811 are formed on the lower face of the of the second substrate 802 at a predetermined pitch so as to extend in the direction orthogonal to the above-described address electrodes 806. Furthermore, a dielectric layer 812 and a passivation film 813 formed of MgO, or the like are formed so as to coat the above-described components.

The first substrate 801 and the second substrate 802 are attached to each other with the address electrodes 806 and the display electrodes 811 facing and orthogonal to each other. The above-described address electrodes 806 and the display electrodes 811 are connected to an AC power supply (not illustrated).

With such a configuration, upon supplying electric power to the electrodes 806 and 807, excited fluorescence is emitted from the fluorescent members 809 of the discharge display portion 803, whereby color display is made.

In this embodiment, the above-described address electrodes 806, the display electrodes 811, and the fluorescent members 809, are formed using the imaging apparatus 1 shown in FIG. 1. Description will be made below about a manufacturing process for the address electrodes 806 formed on the first substrate 801.

In this case, the manufacturing process is performed for the first substrate 801 mounted on the set table 23 of the imaging apparatus 1 according to the manufacturing steps described below.

First, the function liquid droplet ejection head 41 ejects the function liquid droplets, i.e., a liquid material (function liquid) containing a conductive wiring formation material, onto each address electrode formation region. The above-described liquid material contains a dispersion medium and conductive fine particles such as metal particles dispersed therein. Examples of the above-described conductive fine particles include: metal fine particles containing gold, silver, copper, palladium, nickel, or the like; conductive polymer; and so forth.

Upon completion of injection of the liquid material into all the target address electrode formation regions, drying processing is performed for drying the ejected liquid material, thereby evaporating the dispersion medium contained in the liquid material. The address electrodes 806 are thus formed.

While description has been made about the manufacturing process for the address electrodes 806, the above-described manufacturing process may be applied to manufacturing of the above-described display electrodes 811 and fluorescent members 809.

In a case of manufacturing of the display electrodes 811, the function liquid droplets, i.e., a liquid material (function liquid) containing the conductive wiring formation material are ejected onto each display electrode formation region in the same way as with the address electrodes 806.

On the other hand, in a case of manufacturing of the fluorescent members 809, the function liquid droplet ejection head 41 ejects droplets of the liquid material (function liquid) containing a fluorescent material corresponding to any color of red (R), green (G), and blue (B), whereby the droplet in each color lands on the corresponding discharge chamber 805.

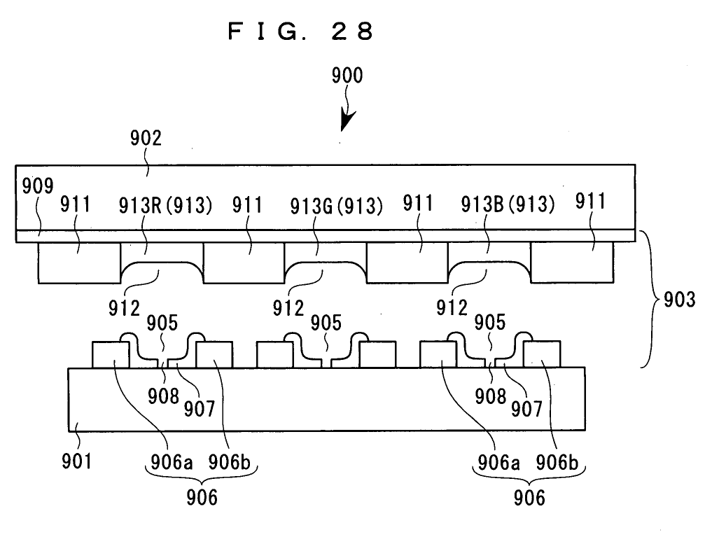

FIG. 28 is a schematic cross-sectional view of an electron emission device (which is also referred to as “FED device” or “SED device”, and will be simply referred to as “display device 900” hereinafter).

The display device 900 generally comprises a first substrate 901 and a second substrate 902 facing one another, and a field emission display portion 903 formed therebetween. The field emission display portion 903 includes a plurality of field emission portions 905 arrayed in the form of a matrix.

Furthermore, first device electrodes 906a and second device electrodes 906b, which form the cathode electrode 906, are formed on the upper face of the first substrate 901 so as to extend orthogonal to each other. Furthermore, each region surrounded by the first device electrodes 906a and the second electrodes 906b includes a conductive film 907 having a gap 908. Namely, the plurality of electron emission portions 905 are formed of the first device electrodes 906a, the second device electrodes 906b, and the conductive films 907. The conductive film 907 is formed of palladium oxide (PdO), or the like. On the other hand, each gap 908 is formed with forming processing, or the like following formation of the conductive film 907.

An anode electrode 909 is formed on the lower face of the second substrate 902 so as to face the cathode electrodes 906, and grid-shaped bank portions 911 are formed on the lower face of the anode electrode 909. Furthermore, each opening 912 surrounded by the bank portions 911 and facing downward includes a fluorescent member 913 corresponding to the electron emission portion 905. The fluorescent member 913 has a function for emitting light in any color of red (R), green (G), and blue (B). Each opening 912 includes any of a red fluorescent member 913R, a green fluorescent member 913G, and a blue fluorescent member 913B, according to a predetermined pattern layout as described above.

Then, the first substrate 901 and the second substrate 902 having such configurations are attached to each other with a small gap therebetween. With the display device 900 having such a configuration, the electrons are emitted from each first device electrode 906a or second device electrode 906b serving as a cathode through the corresponding conductive film 907 (gap 908), and the electrons thus emitted are cast onto the corresponding fluorescent member 913 formed on the anode electrode 909 so as to emit excited light, whereby color display is made.

In this embodiment, the first device electrodes 906a, the second device electrodes 906b, the conductive films 907, and the anode electrode 909, may be formed using the imaging apparatus 1 in the same way as in the other embodiments. Furthermore, the fluorescent members 913R, 913G, 913B, which have the functions for emitting light in red (R), green (G), and blue (B), respectively, may be formed using the imaging apparatus 1.

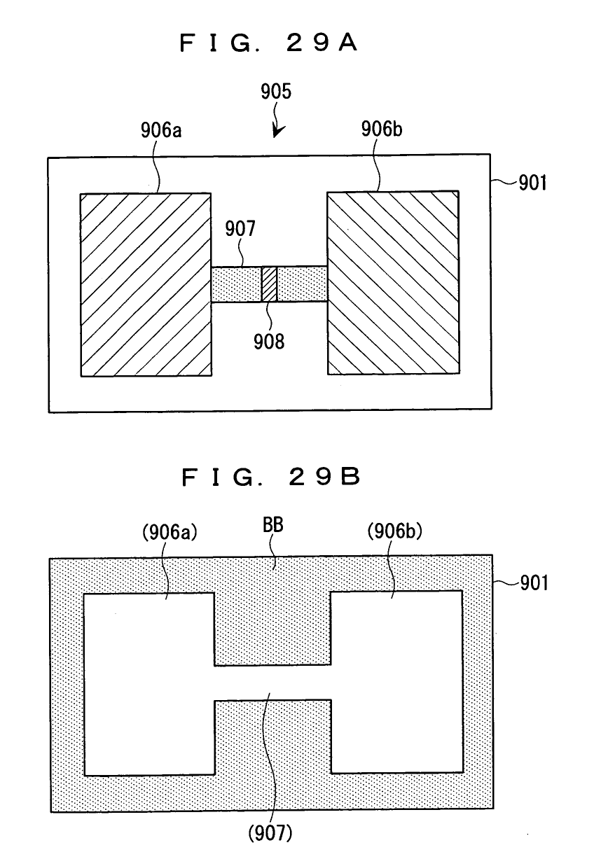

FIG. 29A shows the layout of the first device electrode 906a, the second device electrode 906b, and the conductive film 907. At the time of formation of such a structure, a bank portion BB is formed (in the photolithographic method), except for the regions for forming the first device electrode 906a, the second device electrode 906b, and the conductive film 907, as shown in FIG. 29B.

Next, the first device electrode 906a and the second device electrode 906b are formed in a groove between the bank portion BB (in the ink-jet method using the imaging apparatus 1), following which drying processing is performed for evaporating the solvent, whereby formation of the first device electrode 906a and the second device electrode 906b is completed. Subsequently, the conductive film 907 is formed (in the ink-jet method using the imaging apparatus 1). Following formation of the conductive film 907, the bank portion BB is removed (with the ashing removing processing), following which the procedure proceeds to the above-described forming processing. The first substrate 901 and the second substrate 902 are preferably subjected to lyophilic-surface formation processing, and the bank portions 911 and the bank portions BB are preferably subjected to lyophobic-surface formation processing beforehand in the same way as with the above-described organic EL device.

Furthermore, the method of manufacturing according to this invention may be applied to the manufacturing process for other electro-optical devices such as formation of metal wiring, formation of lenses, formation of a resist pattern, formation of light diffusers, and so forth. As described above, the above-described imaging apparatus 1 according to this invention enables efficient manufacturing of various types of electro-optical devices.

As described above, according to the function liquid supply apparatus of this invention, the function liquid tube to connect the function liquid tank and the function liquid droplet ejection head can be shortened. As a result, the time for the function liquid to travel from the function liquid tank to the function liquid droplet ejection head can be shortened. The amount of air to be dissolved, through the function liquid tube, into the function liquid during the transportation (or flow) of the function liquid can thus be reduced. In addition, due to the reduction in length of the function liquid tube, the loss in the function liquid supply pressure through the function liquid tube can be reduced, whereby a stable supply of the function liquid is possible.

Furthermore, according to the imaging apparatus of this invention, the pressure adjustment valves and the function liquid tanks can be disposed within the region in which the carriage is moved, whereby the entire apparatus can be made smaller in size. Still furthermore, the highly deaerated function liquid can be stably supplied, whereby the function liquid droplets can be ejected from the function liquid droplet ejection head at a high accuracy. This results in an improvement in the imaging accuracy. In addition, since the function liquid flow passages from the function liquid tank to the function liquid droplet ejection head can be shortened in length, there can be reduced waste function liquid which remains inside the function liquid flow passages and which cannot be used any longer.

Furthermore, according to the method of manufacturing the electro-optical device, the electro-optical device, and, the electronic device of this invention, the above-described imaging apparatus of this invention is used. Therefore, a high yield can be attained, and the waste of the function liquid can be minimized.

1. A function liquid supply apparatus for supplying a function liquid to a function liquid droplet ejection head mounted on a carriage, said apparatus comprising:
a function liquid tank for supplying the function liquid;
a pressure adjustment valve comprising: a primary chamber for receiving the function liquid from said function liquid tank; a secondary chamber in fluid flow communication with said primary chamber through a communication flow passage, said secondary chamber being communicated with said function liquid droplet ejection head; and a diaphragm forming one face of said secondary chamber and exposed to atmosphere such that atmospheric pressure received by said diaphragm serves as a reference adjustment pressure to control the fluid flow through the communication flow passage;
a connecting tube for connecting said function liquid tank to said function liquid droplet ejection head through said pressure adjustment valve,
wherein said function liquid tank and said pressure adjustment valve are mounted on said carriage.

2. The function liquid supply apparatus according to claim 1, wherein the manner of mounting said function liquid tank and said pressure adjustment valve on said carriage is such that the function liquid is supplied from said function liquid tank to said function liquid droplet ejection head by natural flow thereof.

3. The function liquid supply apparatus according to claim 1, wherein said function liquid tank is of a vacuum-packed type to store therein the function liquid subjected to degassing processing in advance.

4. The function liquid supply apparatus according to claim 3, further comprising a connection fitting having: a tube connecting portion connected to an upstream end of said connecting tube; and a connecting needle communicated with said tube connecting portion and connected to a supply port of said function liquid tank so as to connect said connecting tube and said function liquid tank together,
wherein said supply port is sealed with an elastic member for detachably receiving therethrough said connecting needle.

5. An imaging apparatus comprising:
said function liquid droplet ejection head and said function liquid supply apparatus according to claim 1,
wherein said function liquid droplet ejection head is driven so as to eject function liquid droplets while performing a relative movement between said carriage and a work, whereby imaging is made on the work with said function liquid droplets.

6. The imaging apparatus according to claim 5, wherein said function liquid droplet ejection head, said pressure adjustment valve, and said function liquid tank are disposed in a straight line.

7. The imaging apparatus according to claim 6, wherein said pressure adjustment valve and said function liquid tank are disposed in a vertical posture.

8. The imaging apparatus according to claim 6, wherein said carriage has mounted thereon plural sets of units, each unit comprising said function liquid droplet ejection head, said pressure adjustment valve, and said function liquid tank disposed in a straight line.

9. The imaging apparatus according to claim 8, wherein said plural sets of units are arrayed in a direction orthogonal to the direction in which said function liquid droplet ejection head, said pressure adjustment valve, and said function liquid tank are disposed in a straight line substantially in a side by side relationship,
and wherein said plurality of function liquid droplet ejection heads contained in said plural sets of units forming said plurality of units are mounted on said carriage in a state of being positioned and fixed to a single head plate.

10. The imaging apparatus according to claim 8, wherein said plurality of pressure adjustment valves contained in said plural sets of units are mounted on said carriage in a state of being positioned and fixed to a single valve plate.

11. The imaging apparatus according to claim 8, wherein said plurality of function liquid tanks contained in said plural sets of units are mounted on said carriage in a state of being positioned and fixed to a single tank plate.

12. A method of manufacturing an electro-optical device wherein a film is formed of said function liquid droplets on the work with said imaging apparatus according to claim 5.

13. An electro-optical device wherein a film is formed of the function liquid droplets on the work with said imaging apparatus according to claim 5.

14. An electronic device having mounted thereon an electro-optical device manufactured by said method of manufacturing an electro-optical device according to claim 12.

15. An electronic device having mounted thereon an electro-optical device according to claim 13.
